(19) United States
(12) Patent Application Publication
(10) Pub. No.: US 2018/0007700 A1
(43) Pub. Date: Jan. 4, 2018

(54) CONTROL APPARATUS, BASE STATION APPARATUS, AND COMMUNICATION SYSTEM

(71) Applicant: FUJITSU LIMITED, Kawasaki-shi (JP)

(72) Inventor: Nobukazu Fudaba, Yokohama (JP)

(73) Assignee: FUJITSU LIMITED, Kawasaki-shi (JP)

(21) Appl. No.: 15/632,780

(22) Filed: Jun. 26, 2017

(30) Foreign Application Priority Data
Jun. 29, 2016 (JP) 2016-129312

(51) Int. Cl. H04W 72/12; H04W 72/04; H04W 36/30; H04W 36/38; H04W 88/12; H04W 74/02

(52) U.S. Cl. CPC H04W 72/12; H04W 88/12; H04W 74/02; H04W 36/30; H04W 36/38; H04W 72/0413

(57) ABSTRACT

A control apparatus coupled to a plurality of base station apparatuses, the control apparatus including a memory and a processor configured to receive base station information transmitted from a terminal apparatus that communicates with one of the plurality of base station apparatuses, the base station information including measurement results for each of a plurality of signals received with reception quality equal to or higher than a reference value at the terminal apparatus, each of the plurality of signals being transmitted from the plurality of base station apparatuses, and perform control to improve reception quality of at least one of the plurality of signals transmitted from the plurality of base station apparatuses other than a specified base station apparatus when the base station information does not satisfy a predetermined condition, the specified base station apparatus being a base station apparatus to which the terminal apparatus is being coupled.

### CROSS-REFERENCE TO RELATED APPLICATION

This application is based upon and claims the benefit of priority of the prior Japanese Patent Application No. 2016-129312, filed on Jun. 29, 2016, the entire contents of which are incorporated herein by reference.

### FIELD

The embodiments discussed herein are related to a control apparatus, a base station apparatus, and a communication system.

### BACKGROUND

In a recent communication system, many base station apparatuses are located with small distance between them to reduce areas in which radio communication is not possible, and therefore a part of a communication area (referred to below as a cell) where a base station apparatus may communicate with terminal apparatuses overlaps with a part of another communication area. Therefore, a terminal apparatus present in an area in which cells overlap is subject to interference caused by radio waves transmitted from a plurality of base station apparatuses. This lowers throughputs in radio communication.

Another factor that lowers throughputs in radio communication is that packets transmitted or received by terminal apparatuses are delayed because many terminal apparatuses exist in the cell of a particular base station apparatus and each terminal apparatus has a reduced chance to be assigned a radio resource.

Thus, a communication system includes a control apparatus that controls the output of radio waves to be transmitted from a plurality of base station apparatuses. The control apparatus controls the base station apparatuses such that cells are configured to reduce interference by radio waves transmitted to terminal apparatuses and suppress concentration of terminal apparatuses in a single base station apparatus. The control apparatus acquires, from each terminal apparatus, information about base station apparatuses with which the terminal apparatus may communicate (this information is referred to below as base station information), and determines an approximate position of the terminal apparatus. The control apparatus controls the transmission outputs of individual base station apparatuses according to their determined positions and changes cell sizes to realize appropriate cell configuration in the entire system.

Techniques related to a control apparatus are described in Japanese Laid-open Patent Publication Nos. 2015-119377, 2014-127976, and 2015-073209.

### SUMMARY

According to an aspect of the invention, a control apparatus coupled to a plurality of base station apparatuses, the control apparatus including a memory and a processor configured to receive base station information transmitted from a terminal apparatus that communicates with one of the plurality of base station apparatuses, the base station information including measurement results for each of a plurality of signals received with reception quality equal to or higher than a reference value at the terminal apparatus, each of the plurality of signals being transmitted from the plurality of base station apparatuses, and perform control to improve reception quality of at least one of the plurality of signals transmitted from the plurality of base station apparatuses other than a specified base station apparatus when the base station information does not satisfy a predetermined condition, the specified base station apparatus being a base station apparatus to which the terminal apparatus is being coupled.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary structure of a communication system;

FIG. 2 illustrates an exemplary structure of a control apparatus;

FIG. 3 illustrates an exemplary structure of a base station apparatus;

FIG. 4 illustrates an exemplary structure of a terminal apparatus;

FIG. 5 illustrates an exemplary sequence of base station control processing;

FIG. 6 illustrates an exemplary processing flowchart of base station information report processing;

FIGS. 7A and 7B illustrate exemplary positional relationships among a terminal apparatus and two cells;

FIG. 8 illustrates an exemplary processing flowchart of assignment stop processing in reception quality improvement processing;

FIG. 9 illustrates exemplary radio resources received by a terminal apparatus;

FIG. 10 illustrates an exemplary processing flowchart of transmission power increase processing in reception quality improvement processing;

FIG. 11 illustrates an exemplary relationship between a terminal apparatus and a cell before and after transmission power increase processing in a neighboring base station apparatus;

FIG. 12 illustrates an exemplary relationship between another terminal apparatus and a cell before and after transmission power increase processing in the neighboring base station apparatus;

FIG. 13 illustrates an exemplary processing flowchart of base station transmission control processing;

FIG. 14 illustrates an exemplary sequence of base station control processing;

FIG. 15 illustrates an exemplary structure of a control apparatus;

FIG. 16 illustrates an exemplary structure of a base station apparatus; and

FIGS. 17A and 17B illustrate an exemplary sequence of base station control processing.

### DESCRIPTION OF EMBODIMENTS

If, however, the number of base station apparatuses indicated in base station information is small, it is difficult for the control apparatus to determine the position of a terminal apparatus with precision high enough to determine a cell size.

For example, if, of the base station apparatuses, only a base station apparatus to which the terminal apparatus is being connected (the base station apparatus is referred to below as the connection-in-progress base station apparatus) is indicated in the base station information, the control apparatus may determine that the terminal apparatus is located in the cell of the connection-in-progress base station apparatus, but fails to determine positional relationships among the terminal apparatus and other base station apparatuses. In this case, if the transmission output of another base station apparatus close to the terminal apparatus is raised, interference may occur in the terminal apparatus. Another problem is that terminal apparatuses may concentrate in the cell in which the transmission output has been raised. Therefore, to realize more appropriate cell configuration, the number of base station apparatuses indicated in base station information is preferably large.

In an aspect of the disclosure, a control apparatus, a base station apparatus, a communication system, and a base station apparatus control method that increase the number of base station apparatuses indicated in base station information are provided.

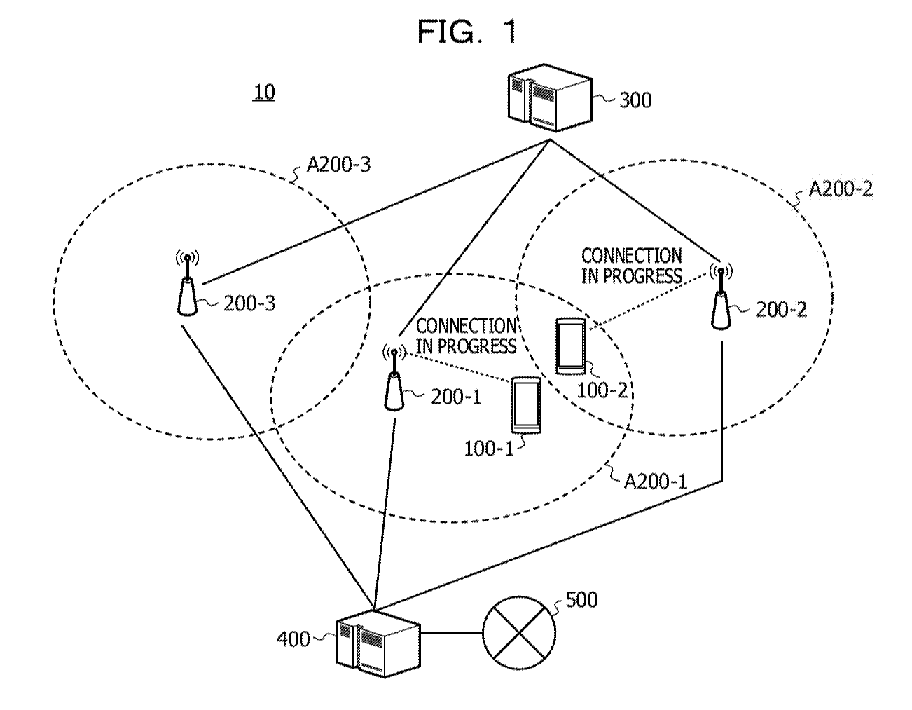

FIG. 1 illustrates an exemplary structure of a communication system 10. The communication system 10 includes terminal apparatuses 100-1 and 100-2 (may be referred to below as the terminal apparatuses 100), base station apparatuses 200-1 to 200-3 (may be referred to below as the base station apparatuses 200), a control apparatus 300, a gateway 400, and an external network 500. The base station apparatuses 200-1 to 200-3 have cells A200-1 to A200-3, respectively. The terminal apparatus 100-1 located in the cell A200-1 may wirelessly communicate with the base station apparatus 200-1, which has the cell. The terminal apparatus 100-2 located in the cells A200-1 and A200-2 may wirelessly communicate with the base station apparatuses 200-1 and 200-2, each of which has the relevant cell.

The communication system 10 is, for example, a local area network, such as a Wireless Fidelity (Wi-Fi) network, or a radio communication network, such as a Long Term Evolution (LTE) network. The communication system 10 is, for example, a communication system that enables the terminal apparatuses 100-1 and 100-2 to communicate so that the terminal apparatuses 100-1 and 100-2 receive services from the external network 500, which is, for example, the Internet. The terminal apparatuses 100-1 and 100-2 achieve communication by transmitting and receiving packets to and from the external network 500 through the base station apparatuses 200 and the gateway 400.

Each cell configuration (cell size) in the communication system 10 is controlled so that the throughputs of the terminal apparatuses 100-1 and 100-2 in radio communication are not lowered. In this control, the control apparatus 300 controls the outputs of radio waves transmitted from the base station apparatuses 200-1 to 200-3 by adjusting the cell radii of the cells A200-1 to A200-3.

The base station apparatuses 200-1 to 200-3 relay packets transmitted and received by the terminal apparatuses 100-1 and 100-2. The base station apparatuses 200-1 to 200-3 are, for example, evolved nodes B (eNodeBs) in LTE or access points in Wi-Fi. The base station apparatuses 200-1 to 200-3 periodically transmit a measurement-use signal that causes the terminal apparatuses 100-1 and 100-2 to detect the base station apparatus 200-1 to 200-3. Each measurement-use signal may include, for example, one of the identifiers of the base station apparatuses 200-1 to 200-3. That is, the measurement-use signal is, for example, a reference signal transmitted by an eNodeB in LTE or an access point in Wi-Fi to measure reception quality. The measurement-use signal is transmitted at a predetermined frequency. The terminal apparatuses 100-1 and 100-2 may detect a base station apparatus 200 in the vicinity of the terminal apparatuses 100-1 and 100-2 by searching for a radio wave at the predetermined frequency at which the measurement-use signal is transmitted.

When located in the cells A200-1 to A200-3, the terminal apparatuses 100-1 and 100-2 are wirelessly connected to the base station apparatuses 200-1 to 200-3 and transmit and receive packets. The terminal apparatus 100-1 is being connected to the base station apparatus 200-1, and the terminal apparatus 100-2 is being connected to the base station apparatus 200-2. The terminal apparatuses 100-1 and 100-2 measure a measurement-use signal periodically or in response to a request from the control apparatus 300 and transmit measurement results to the control apparatus 300 as base station information.

The control apparatus 300 acquires, from the terminal apparatus 100 through the base station apparatus 200, the base station information that includes results of measurements performed by the terminal apparatus 100 about measurement-use signals transmitted from the base station apparatus 200. The terminal apparatus 100 transmits, to the control apparatus 300, measurement results for measurement-use signals having reception quality equal to or higher than a reference value, the measurement-use signal being part of the received measurement-use signals, as the base station information. Therefore, the base station information includes measurement results for base station apparatuses 200 that had transmitted a measurement-use signal received by a terminal apparatus 100 with reception quality equal to or higher than the reference value.

The reference value indicates, for example, reception quality at which a terminal apparatus 100 may wirelessly communicate with a base station apparatus 200; the reference value indicates received power or the degree of interference. The measurement result includes, for example, the identifier of a base station apparatus 200 and received power. The control apparatus 300 determines the position of the terminal apparatus 100 from the acquired base station information, and controls transmission outputs of the base station apparatuses 200-1 to 200-3 according to the determined result. The position, determined by the control apparatus 300, of the terminal apparatus 100 is indicated not only by coordinates but also by, for example, a distance in terms of a radio wave, which indicates the amount of loss (or attenuation) caused by the radio wave transmitted from the base station apparatus 200. When the position of the terminal apparatus 100 is indicated by a relative position, the position may be represented with respect to power received at the terminal apparatus 100. An example of the relative position is a position at which the radio wave transmitted from the base station apparatus 200 is received at power that is 20 decibel (dB) lower than the power at the base station apparatus 200.

If it is difficult for the control apparatus 300 to determine the position of the terminal apparatus 100 from the acquired base station information or the precision of the position determined from the acquired base station information is low, the control apparatus 300 controls the transmission outputs of the base station apparatuses 200 adjacent to the cell in which the terminal apparatus 100 is located so that the reception quality of the measurement-use signal is improved.

In the example in FIG. 1, the terminal apparatus 100-2 is located in two cells, A200-1 and A200-2. Therefore, base station information transmitted from the terminal apparatus 100-2 includes measurement results for two base station apparatuses in total, one of which is the base station apparatus 200-2, which is being connected to the terminal apparatus 100-2 (the connected base station apparatus is referred to below as a connection-in-progress base station apparatus), and the other of which is the base station apparatus 200-1, which is not being connected to the terminal apparatus 100-2 but may communicate with it. Therefore, the control apparatus 300 is able to determine that the terminal apparatus 100-2 is located in an area in which two cells, A200-1 and A200-2, overlap.

By contrast, the terminal apparatus 100-1 is located in only one cell, A200-1. Therefore, base station information transmitted from the terminal apparatus 100-1 includes a measurement result only for the base station apparatus 200-1, which is the connection-in-progress base station apparatus 200.

Therefore, the control apparatus 300 may determine that the terminal apparatus 100-1 is located in the cell A200-1 but fails to determine positional relationship to the base station apparatuses 200-2 and 200-3. Therefore, the control apparatus 300 determines that the terminal apparatus 100-1 is such that the precision of the determined position is low, so the control apparatus 300 performs control so that the reception quality of the measurement-use signals from the base station apparatuses 200-2 and 200-3 adjacent to the base station apparatus 200-1 is improved.

After the control apparatus 300 has performed control so that the reception quality of the measurement-use signals is improved, the control apparatus 300 acquires base station information again from the relevant terminal apparatuses. Since the reception quality of the measurement-use signals at the relevant terminal apparatuses has been improved, measurement-use signals may be received from base station apparatuses (referred to below as neighboring base station apparatuses) other than the connection-in-progress base station apparatus with reception quality equal to or higher than the reference value. Therefore, the provability that the number of base station apparatuses indicated in base station information to be transmitted again is improved.

### First Embodiment

As described above, in a first embodiment, the control apparatus controls transmission processing performed by a plurality of base station apparatuses. The control apparatus also receives, from each terminal apparatus, base station information including measurement results for measurement-use signals received with reception quality equal to or higher than the reference value at the terminal apparatus, these measurement-use signals being part of measurement-use signals transmitted from the base station apparatuses and used by the terminal apparatus to detect the base station apparatuses. In addition, if the acquired base station information does not satisfy a predetermined condition, the control apparatus performs control so that the reception quality of measurement-use signals transmitted from base station apparatuses other than the connection-in-progress base station apparatus to which the terminal apparatus is being connected is improved.

Exemplary Structure of Control Apparatus

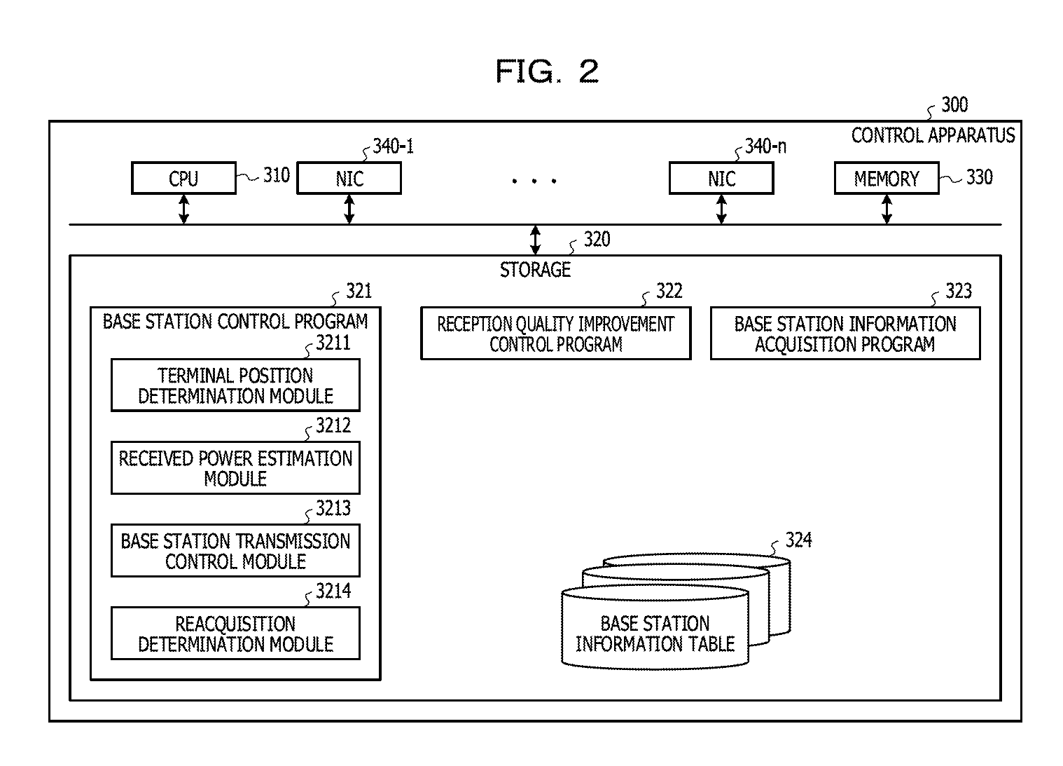

FIG. 2 illustrates an exemplary structure of the control apparatus 300. The control apparatus 300, which is, for example, a computer, includes a central processing unit (CPU) 310, a storage 320, a memory 330 such as a dynamic random-access memory (DRAM), and network interface cards (NICs) 340-1 to 340-n.

The storage 320 is an auxiliary storage that stores programs and data. Examples of the storage 320 include a hard disk drive (HDD) and a solid state drive (SSD). The storage 320 stores a base station control program 321, a reception quality improvement control program 322, a base station information acquisition program 323, and a base station information table 324.

The base station information table 324 stores base station information acquired from terminal apparatuses 100 for each terminal apparatus 100. For example, the base station information table 324 stores the identifiers of base station apparatuses 200, the received power of measurement-use signals, and the like.

The memory 330 is an area into which programs stored in the storage 320 are loaded. The memory 330 is also used as an area in which programs store data.

The NICs 340-1 to 340-n are connected to base station apparatuses 200 and a network to establish communication. The NICs 340-1 to 340-n may be connected to other base station apparatuses 200 through a hub and switches.

The CPU 310 loads programs stored in the storage 320 into the memory 330 and executed the loaded programs to implement various processes.

The CPU 310 executes the base station control program 321 and modules 3211 to 3214 to construct a control unit and implement base station control processing. In base station control processing, transmission outputs of base station apparatuses 200 are controlled.

The CPU 310 executes the terminal position determination module 3211 to implement terminal position determination processing performed by the control unit. In terminal position determination processing, the control apparatus 300 determines the position of a terminal apparatus 100 according to the identifiers of the base station apparatuses 200 that had transmitted the measurement-use signal received by the terminal apparatus 100 and to the received power of the measurement-use signal or estimated received power, the identifier and received power being indicated in the acquired base station information.

The CPU 310 executes the received power estimation module 3212 to implement received power estimation processing performed by the control unit. In received power estimation processing, the received power of a measurement-use signal transmitted from a neighboring base station apparatus 200 and received at a terminal apparatus 100 is estimated from the reception sensitivity of the terminal apparatus 100, the time variation of received power at the terminal apparatus 100, and the like.

The CPU 310 executes the base station transmission control module 3213 to implement base station transmission control processing performed by the control unit. In base station transmission control processing, the transmission output of the base station apparatus 200 is controlled so that an appropriate cell size is obtained, according to the position, determined in terminal position determination processing, of the terminal apparatus. An appropriate cell size is a cell size at which the throughput of the terminal apparatus is not lowered. Examples of an appropriate cell size are a cell size at which terminal apparatuses 100 are not concentrated in a particular base station apparatus 200 and a cell size at which a terminal apparatus is not located an area in which cells overlap.

The CPU 310 executes the reacquisition determination module 3214 to implement reacquisition decision processing performed by the control unit. In reacquisition decision processing, the control apparatus 300 determines whether the position of the terminal apparatus may be determined with precision enough to construct an appropriate cell configuration, according to the measurement result included in acquired base station information. If, for example, a measurement result only for the connection-in-progress base station apparatus 200 is included in base station information transmitted from a certain terminal apparatus, the control apparatus 300 may determine that the terminal apparatus is located in the cell of the connection-in-progress base station apparatus to which the terminal apparatus is being connected. However, it is difficult for the control apparatus 300 to determine the position of the terminal apparatus in the cell and to determine its positional relationships with neighboring base station apparatuses.

If the precision of the position of the terminal apparatus is low as described above, when the control apparatus 300 tries to reduce radio wave interference or alleviate congestions of terminal apparatuses in a cell, it is difficult for the control apparatus 300 to control the cell to an appropriate cell size. In view of this, if the control apparatus 300 in the first embodiment determines that the precision of the position of the terminal apparatus determined from acquired base station information alone is low, the control apparatus 300 causes the reception quality of a measurement-use signal transmitted from neighboring base station apparatuses to be improved and acquires (receives) base station information again.

The CPU 310 executes the reception quality improvement control program 322 to construct a control unit and implement reception quality improvement processing. In reception quality improvement processing, the base station apparatuses 200-1 to 200-3 are commanded to execute processing to improve the reception quality of the measurement-use signal. When the control apparatus 300 decides to acquire base station information again in reacquisition decision processing, the control apparatus 300 executes reception quality improvement processing.

The CPU 310 executes the base station information acquisition program 323 to construct a receiving unit and implement base station information acquisition processing. In base station information acquisition processing, the control apparatus 300 requests each terminal apparatus to report base station information to the control apparatus 300 through a connection-in-progress base station apparatus. The control apparatus 300 receives base station information and stores it in the base station information table 324 for each terminal apparatus.

Exemplary Structure of Base Station Apparatus

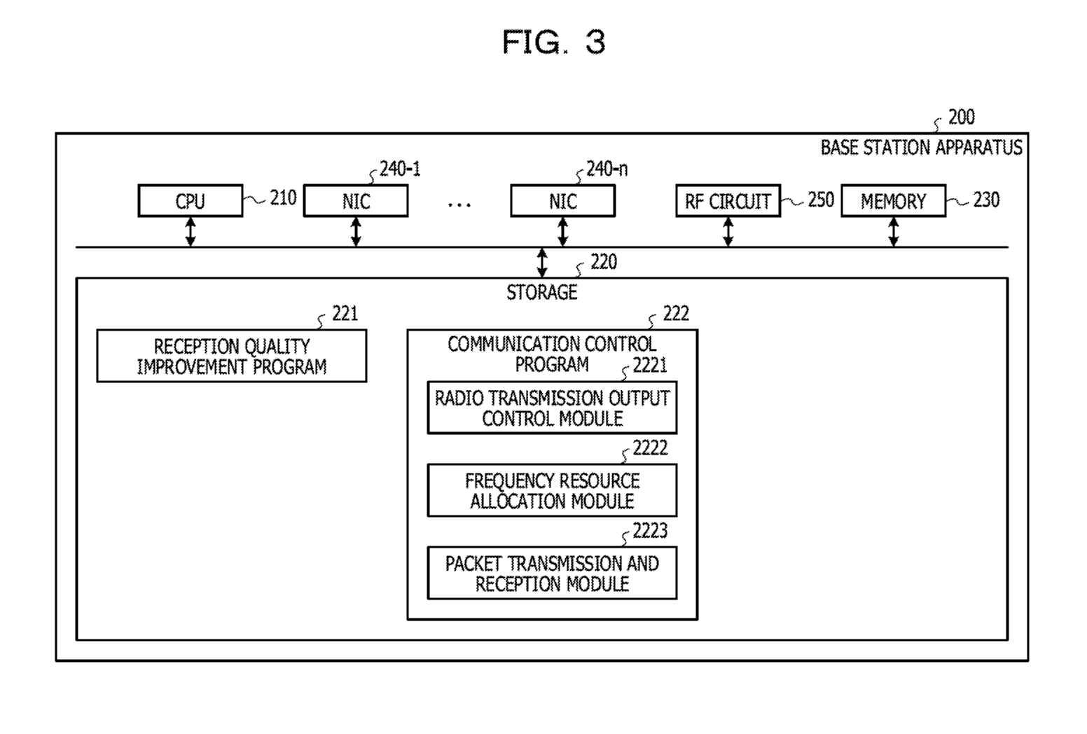

FIG. 3 illustrates an exemplary structure of the base station apparatus 200. The base station apparatus 200 has a CPU 210, a storage 220, a memory 230, NICs 240-1 to 240-n, and a radio frequency (RF) circuit 250.

The CPU 210, storage 220, memory 230, and NICs 240-1 to 240-n are respectively similar to the CPU 310, storage 320, memory 330, and NICs 340-1 to 340-n in FIG. 2.

However, the storage 220 stores a reception quality improvement program 221 and a communication control program 222. The RF circuit 250 is a device that implements radio wave transmission and reception through an antenna. The RF circuit 250 wirelessly communicates with, for example, a terminal apparatus located in the cell of the base station apparatus in which the RF circuit 250 is included.

The CPU 210 executes the reception quality improvement program 221 to construct a reception quality improvement processing unit and implement reception quality improvement processing. In reception quality improvement processing, the base station apparatus 200 executes processing to raise the transmission output power of a measurement-use signal, processing not to assign a data channel other than a measurement-use signal to a frequency resource to which a measurement-use signal is to be mapped, and other processing. After having performed the processing to improve the reception quality of a measurement-use signal, the base station apparatus 200 requests a terminal apparatus to report base station information to the base station apparatus 200. The base station apparatus 200 then receives the base station information from the terminal apparatus and transmits the received base station information to the control apparatus 300, after which the base station apparatus 200 stops the processing to improve the reception quality of a measurement-use signal, and returns to the state taken before the reception quality improvement processing has been executed. If the base station apparatus 200 fails to receive base station information from the terminal apparatus within a predetermined time, then the base station apparatus 200 may stop the processing to improve the reception quality of a measurement-use signal and may return to the state taken before the reception quality improvement processing has been executed.

The CPU 210 executes the communication control program 222 to construct a communication unit and implement communication control processing. In communication control processing, communication with the terminal apparatus 100 is controlled. The communication unit receives base station information from the terminal apparatus 100 and transmits the received base station information to the control apparatus 300.

The CPU 210 executes a radio transmission output control module 2221 to implement radio transmission output control processing. In radio transmission output control processing, the base station apparatus 200 changes the output of a radio transmission wave transmitted from the RF circuit 250. In a case in which the reception quality improvement processing unit raises the transmission output power of a measurement-use signal, the base station apparatus 200 executes radio transmission output control processing to raise the output of the radio transmission wave.

The CPU 210 executes a frequency resource allocation module 2222 to implement frequency resource allocation processing. In frequency resource allocation processing, a frequency resource used for communication to the terminal apparatus is assigned. When the reception quality improvement processing unit suppresses a data channel other than a measurement-use signal from being assigned to a frequency resource to which a measurement-use signal is to be mapped, the base station apparatus 200 executes frequency resource allocation processing.

The CPU 210 executes a packet transmission and reception module 2223 to implement packet transmission and reception processing. In packet transmission and reception processing, packets to be transmitted and received between terminal apparatuses and between a terminal apparatus and a network are relayed.

Exemplary Structure of Terminal Apparatus

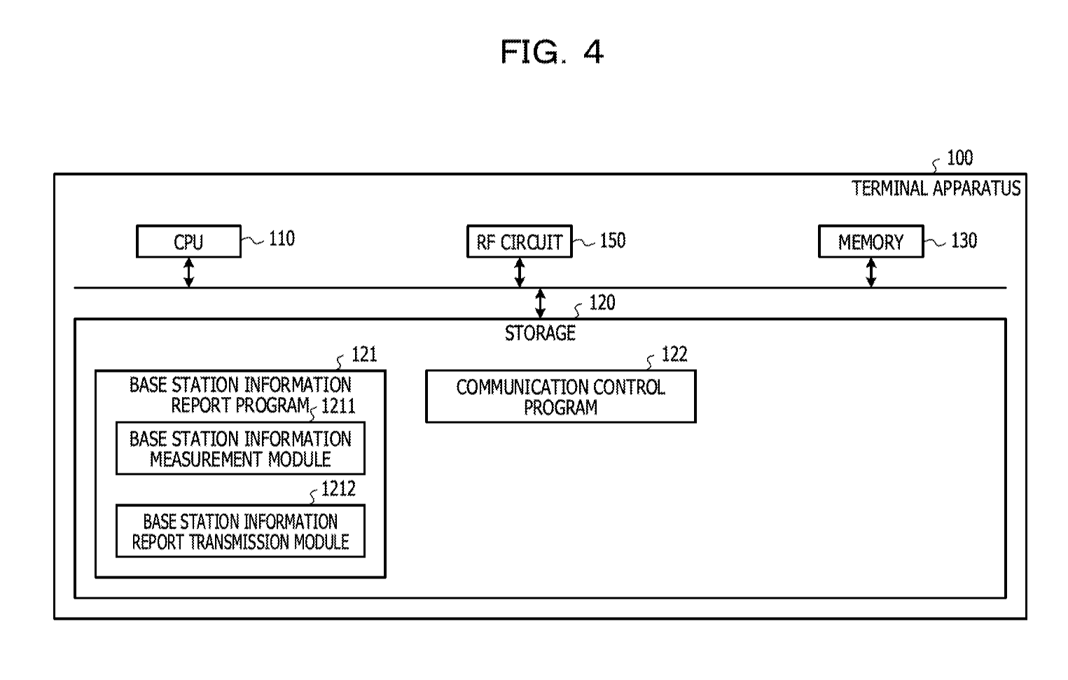

FIG. 4 illustrates an exemplary structure of the terminal apparatus 100. The terminal apparatus 100 has a CPU 110, a storage 120, a memory 130, and an RF circuit 150.

The CPU 110, storage 120, memory 130, and RF circuit 150 are respectively similar to the CPU 210, storage 220, memory 230, and RF circuit 250 in FIG. 3.

However, the storage 120 stores a base station information report program 121 and communication control program 122.

The CPU 110 executes the base station information report program 121 to implement base station information report processing. In base station information report processing, base station information is measured and a measurement result is reported to the control apparatus 300.

The CPU 110 executes a base station information measurement module 1211 to implement base station information measurement processing. In base station information measurement processing, a measurement-use signal transmitted from the base station apparatus 200 is searched for and received, and then the reception quality of the received measurement-use signal such as received power and the degree of interference is measured.

The CPU 110 executes a base station information report transmission module 1212 to implement base station information report transmission processing. In base station information report transmission processing, measurement results for measurement-use signals received with reception quality equal to or higher than the reference value are transmitted to the control apparatus 300 as base station information reports, these measurement-use signals being part of measurement-use signals transmitted from the base station apparatus 200 and used by a terminal apparatus to detect the base station apparatus 200.

The CPU 110 executes the communication control program 122 to implement communication control processing. In communication control processing, communication with another terminal apparatus or a network through a base station apparatus 200 is controlled.

Base Station Control Processing

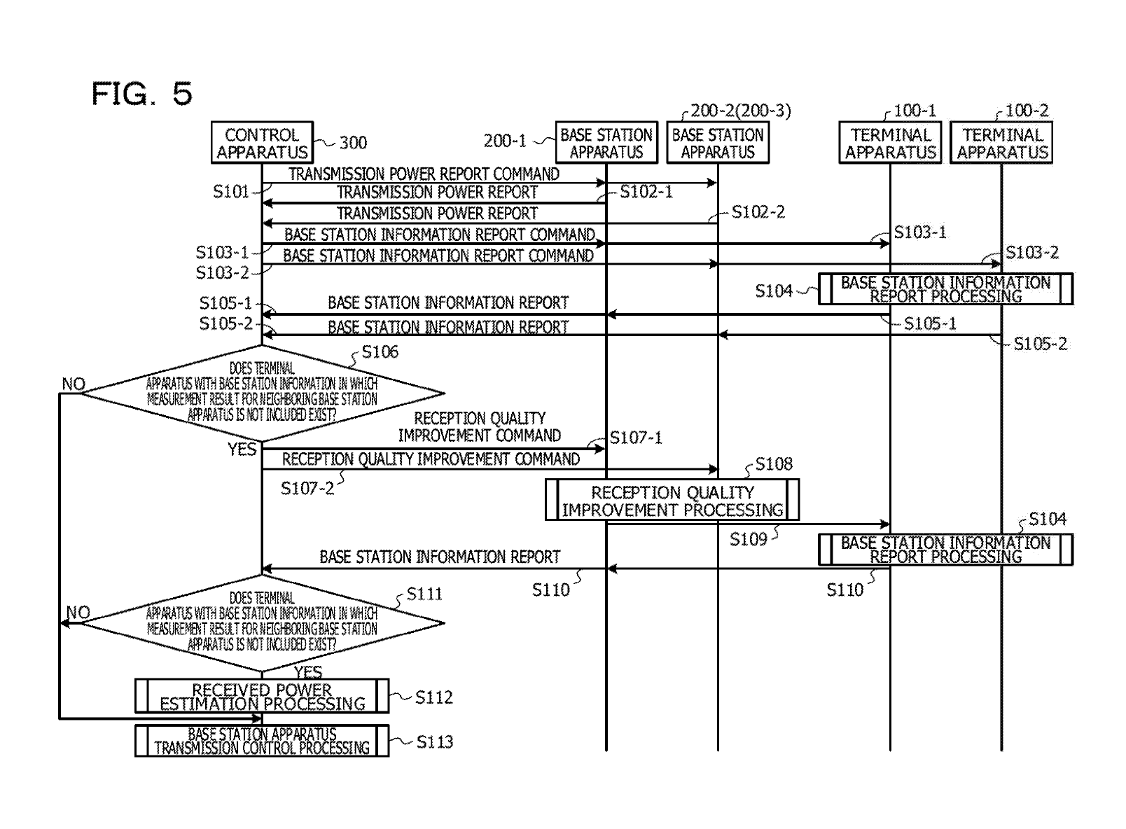

FIG. 5 illustrates an exemplary sequence of base station control processing. Base station information acquisition processing is described below with reference to FIG. 5. In FIG. 5, the base station apparatus 200-3 is omitted.

To execute base station apparatus transmission control processing (S113), the control apparatus 300 executes base station information acquisition processing (S101 to S110) to acquire base station information from terminal apparatuses 100.

At that time, the base station apparatus 200 executes reception quality improvement processing (S108) in base station apparatus transmission control processing. As a result, the control apparatus 300 executes received power estimation processing (S112) and then executes base station apparatus transmission control processing (S113).

Base station acquisition processing (S101 to S110), reception quality improvement processing (S108), received power estimation processing (S112), and base station apparatus transmission control processing (S113) are described below in that order.

1. Base Station Information Acquisition Processing

As illustrated in FIG. 5, the control apparatus 300 transmits a transmission power report command to the base station apparatuses 200-1 to 200-3 to acquire the transmission power of a radio wave transmitted from each of these base station apparatuses 200 (S101). These base station apparatuses 200-1 to 200-3 receive the transmission power report command and report the transmission power of the base station apparatuses 200-1 to 200-3 to the control apparatus 300 as a transmission power report (S102-1 and S102-2). The reason why the control apparatus 300 acquires transmission power from each base station apparatus 200 is that transmission power is used to calculate a path loss between the base station apparatus and the terminal apparatus, which is an index to determine the position of the terminal apparatus.

Next, the control apparatus 300 transmits a base station information report command, which requests a report of base station information, to all terminal apparatuses 100 that are being connected, through the relevant base station apparatus 200 that is a connection-in-progress base station apparatus 200 (S103-1 and S103-2). The terminal apparatuses 100-1 and 100-2 receive the base station information report command and execute base station information report processing (S104).

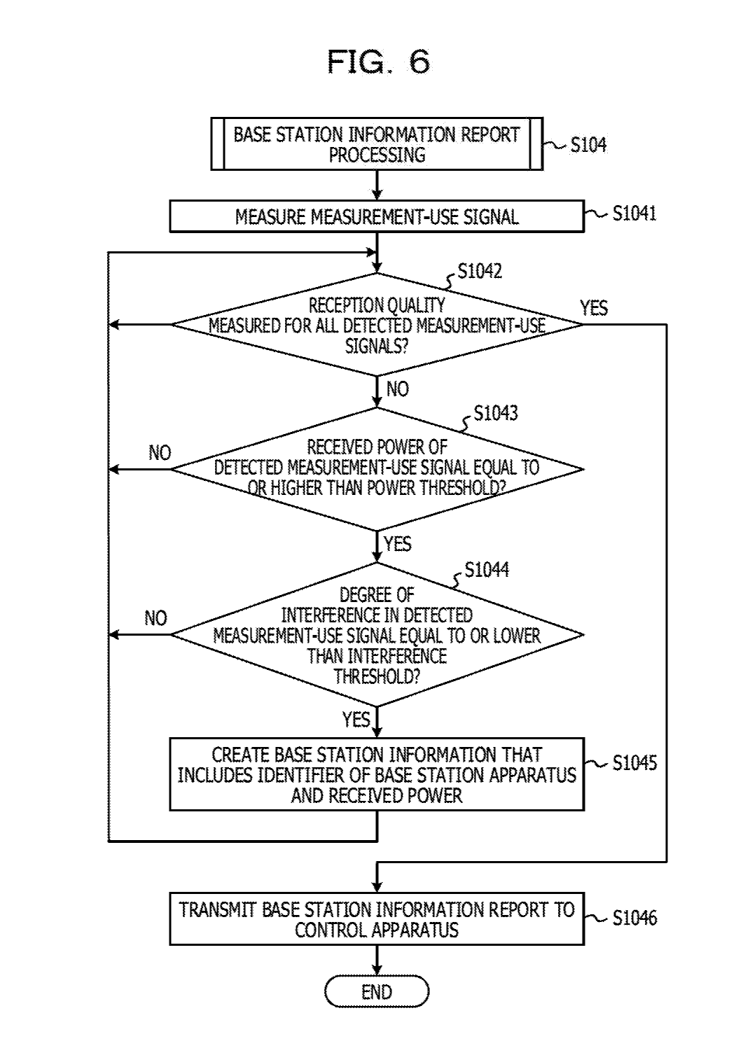

FIG. 6 illustrates an exemplary processing flowchart of base station information report processing. The terminal apparatus 100 measures a measurement-use signal (S1041). In the measurement of the measurement-use signal, the terminal apparatus 100 acquires a radio wave at a frequency at which the measurement-use signal is transmitted and detects a measurement-use signal mapped to a radio wave at the acquired frequency.

The terminal apparatus 100 decides whether reception quality has been measured for all base station apparatuses 200 from which the detected measurement-use signal had been transmitted (S1042).

If reception quality has not been measured for all base station apparatuses 200 (No in S1042), the terminal apparatus 100 decides whether the received power of the detected measurement-use signal is equal to or higher than a power threshold (first threshold) (S1043). The received power is received power of a measurement-use signal transmitted from the base station apparatus 200. An example of the received power is reference signal received power (RSRP) in a communication system in LTE. The power threshold is, for example, the minimum power with which a terminal apparatus 100 may communicate with a base station apparatus 200.

If the received power is equal to or higher than the power threshold (Yes in S1043), the terminal apparatus 100 decides whether the degree of interference in the detected measurement-use signal is equal to or lower than an interference threshold (second threshold) (S1044). The degree of interference indicates the degree of interference generated in the received measurement-use signal. An example of the degree of interference is a signal-to-interference plus noise power ratio (SINR). The SINR indicates that the larger its value is, the lower the degree of interference is. The degree of interference is, for example, the minimum value at which a radio wave at the relevant frequency may be used in communication.

If the degree of interference is equal to or lower than the interference threshold (Yes in S1044), the terminal apparatus 100 creates base station information that includes the identifier of the base station apparatus 200 from which the measurement-use signal has been transmitted and the received power of the measurement-use signal (S1045).

As described above, the terminal apparatus 100 decides, for all measurement-use signals, whether their reception quality is equal to or higher than the reference value (S1043 and S1044) (Yes in S1042). Thus, the terminal apparatus 100 creates base station information including measurement results for base station apparatuses 200 that had transmitted a measurement-use signal having reception quality equal to or higher than the reference value (that is, having received power equal to or higher than the power threshold and the degree of interference equal to or lower than the interference threshold) (S1045). The created base station information includes received power, which is a measurement result for each measurement-use signal having reception quality equal to or higher than the reference value and also include the identifier of the base station apparatus 200 that had transmitted the measurement-use signal.

The terminal apparatus 100 then transmits the created base station information to the control apparatus 300 through the base station apparatus 200 as a base station information report (S1046).

If the received power of a measurement-use signal is lower than the power threshold (No in S1043), the terminal apparatus 100 does not include, in the base station information, the received power and the identifier of the base station apparatus 200 that had transmitted the measurement-use signal. Similarly, if the degree of interference is larger than the interference threshold (No in S1044), the terminal apparatus 100 does not include the received power and identifier in the base station information.

Referring again to the sequence in FIG. 5, each of the terminal apparatuses 100-1 and 100-2 transmit a base station information report to the control apparatus 300 through the relevant connection-in-progress base station apparatus 200 (S105-1 and S105-2). The control apparatus 300 receives the base station information report from each terminal apparatus 100 and executes reacquisition decision processing, in which whether the received base station information satisfies a predetermined condition is decided (S106). If the base station information does not satisfy the predetermined condition, the control apparatus 300 decides that base station information is desired to be acquired again.

The predetermined condition in reacquisition decision processing in S106 in the sequence in FIG. 5 is that there is no terminal apparatus having acquired base station information in which a measurement result for a neighboring base station apparatus 200 is not included. That is, if base station information received from a certain terminal apparatus indicates a measurement result only for the connection-in-progress base station apparatus 200, the control apparatus 300 decides that the predetermined condition is not satisfied.

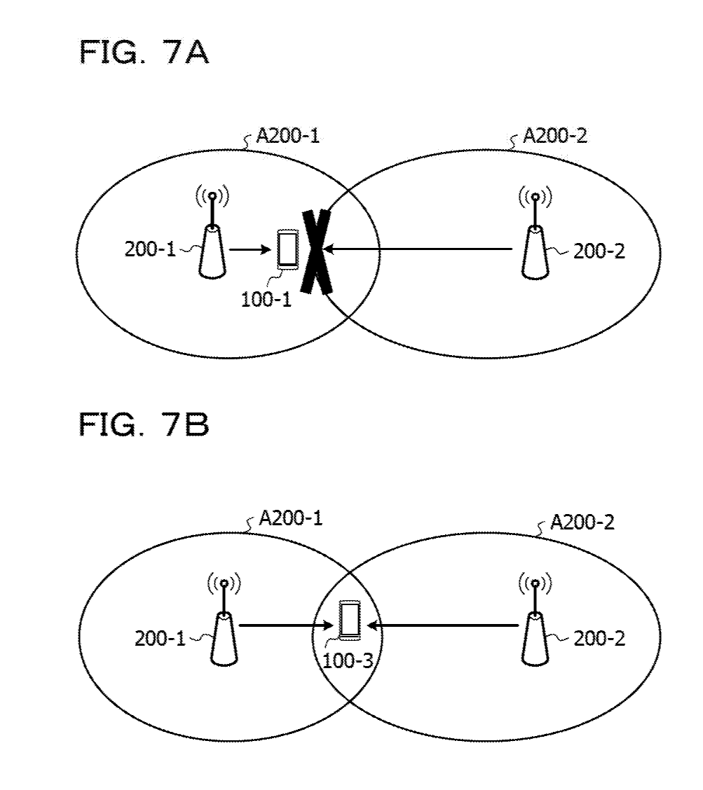

Now, the position of a terminal apparatus 100 in a case in which information about a neighboring base station apparatus is not included in the base station information is described. FIGS. 7A and 7B illustrate exemplary positional relationships among the terminal apparatus 100 and the cells A200-1 and A200-2.

Although the terminal apparatus 100-1 in FIG. 7A is in the cell A200-1 of the connection-in-progress base station apparatus 200-1, the terminal apparatus 100-1 is located in an area outside the cell A200-2 of the neighboring base station apparatus 200-2 (the area is referred to below as the first area). In measurements of measurement-use signals, the terminal apparatus 100-1 may receive a measurement-use signal transmitted from the connection-in-progress base station apparatus 200-1 at received power equal to or higher than the power threshold, but fails to receive a measurement-use signal transmitted from the base station apparatus 200-2 in the neighboring cell at received power equal to or higher than the power threshold because of a long distance from the neighboring base station apparatus 200-2. Therefore, since the reception quality of the measurement-use signal transmitted from the neighboring base station apparatus 200-2 is lower than the reference value, a measurement result for the neighboring base station apparatus 200-2 is not included in the base station information.

In the first area, however, interference due to a radio wave transmitted from another base station apparatus does not occur, so the degree of interference in the terminal apparatus 100-1 is equal to or lower than the interference threshold. Therefore, since the measurement-use signal transmitted from the base station apparatus 200-1 is such that its received power is equal to or higher than the reference power and its degree of interference is equal to or lower than the interference threshold, that is, the reception quality of the measurement-use signal is equal to or higher than the reference value, a measurement result for the base station apparatus 200-1 is included in the base station information.

The terminal apparatus 100-3 in FIG. 7B is located in an area in which the cell A200-1 of the connection-in-progress base station apparatus 200-1 and the cell A200-2 of the neighboring base station apparatus 200-2 overlap (the area is referred to below as the second area). In measurements of measurement-use signals, the terminal apparatus 100-3 may receive measurement-use signals transmitted from the base station apparatuses 200-1 and 200-2 with received power equal to or higher than the power threshold.

In the second area, however, an interference due to radio waves transmitted from the base station apparatuses 200-1 and 200-2, the degree of interference in the terminal apparatus 100-3 may be higher than the interference threshold. This occurs when, for example, many terminal apparatuses located in the cell A200-2 are being connected to or are communicating with the base station apparatus 200-2 and many radio waves have arrived in the second area.

Therefore, the reception quality of the measurement-use signal transmitted from the base station apparatus 200-2 falls below the reference value, so a measurement result for the base station apparatus 200-2 is not included in the base station information.

Although interference may also have been generated in the measurement-use signal transmitted from the base station apparatus 200-1, the degree of interference is thought to be equal to or lower than the interference threshold because the terminal apparatus 100-3 is being connected to the base station apparatus 200-1. This is because a terminal apparatus is generally connected to a base station apparatus with superior reception quality. Therefore, a measurement result for the base station apparatus 200-1 is included in the base station information.

As described above, a case in which information about the neighboring base station apparatus 200-2 is not included in base station information occurs when the terminal apparatus 100-1 is located in the first area and when the terminal apparatus 100-3 is located in the second area and interference has been generated in a measurement-use signal transmitted from the neighboring base station apparatus. Although the terminal apparatus 100-3 is located in an area in which cells of a plurality of base station apparatuses overlap as with the terminal apparatus 100-2 in FIG. 1, different base station information is acquired because the situation around the terminal apparatus 100-3 differs from the situation around the terminal apparatus 100-2.

As described above, when the predetermined condition is not satisfied, that is, information about any neighboring base station apparatus is not included in base station information, the terminal apparatus is located in the first area or second area. Therefore, to determine whether the terminal apparatus is positioned in the first area or second area, the control apparatus 300 executes quality improvement processing and decides that base station information about the terminal apparatus is desirably acquired again. When the control apparatus 300 executes quality improvement processing described later, the terminal apparatus 100-3 located in the second area may easily receive a measurement-use signal from the base station apparatus 200-2 (neighboring base station apparatus) in the neighboring area A200-2 with reception quality higher than the reference value. As a result of quality improvement processing, the terminal apparatus 100-1 located in the first area is regarded as a terminal apparatus in the second area and is predicted to fail to receive a measurement-use signal from the neighboring base station apparatus 200-2 with reception quality equal to or higher than the reference value due to radio wave interference. Therefore, the control apparatus 300 may decide that a terminal apparatus from which a measurement result for the neighboring base station apparatus is acquired in the reacquisition of base station information after the execution of quality improvement processing is located in the second area. By contrast, the control apparatus 300 may decide that a terminal apparatus from which a measurement result for the neighboring base station apparatus failed to be acquired in the reacquisition of base station information after the execution of quality improvement processing is located in the first area.

The predetermined condition in reacquisition decision processing in S106 in the sequence in FIG. 5 may be that the number of neighboring base station apparatuses indicated in the acquired base station information is equal to or larger than a reference value. The more the number of base station apparatuses indicated in base station information is, the higher precision in the determination of the position of the terminal apparatus is. Therefore, the control apparatus 300 preferably acquires measurement results for more base station apparatuses.

If the control apparatus 300 decides that reacquisition of base station information is preferable as a result of reacquisition decision processing in S106 (Yes in S106), the control apparatus 300 causes reception quality improvement processing, by which the reception quality of a measurement-use signal is improved, to be executed so that a measurement result for the neighboring base station apparatus is included in base station information.

FIG. 5 illustrates a case in which reception quality improvement processing is executed for all base station apparatuses. To cause all base station apparatuses, 200-1 to 200-3, to execute reception quality improvement processing, the control apparatus 300 transmits a reception quality improvement command to the base station apparatuses 200-1 to 200-3 (S107-1 and S107-2). If reception quality improvement processing is assignment stop processing, which is described later, the control apparatus 300 transmits a reception quality improvement command to all base station apparatuses 200. If reception quality improvement processing is transmission output (power) increase processing, which is described later, the control apparatus 300 transmits a reception quality improvement command only to neighboring base station apparatuses.

Each base station apparatus 200 receives the reception quality improvement command and executes reception quality improvement processing according to the received reception quality improvement command (S108). Details of reception quality improvement processing are described later. If a terminal apparatus that is being connected to a base station apparatus 200 (base station apparatus 200-1, for example) is a terminal apparatus (terminal apparatus 100-1, for example) from which to acquire base station information again, the base station apparatus 200 transmits a base station information report command to the terminal apparatus 100-1 (S109).

The terminal apparatus 100-1 to which to transmit a base station information report command is a terminal apparatus for which a decision has been made in reacquisition decision processing (S106), the decision being that reacquisition of base station information from the terminal apparatus is desired. However, the reception quality of a measurement-use signal is improved by executing reception quality improvement processing in S108. Therefore, there is the possibility that measurement results for more neighboring base station apparatuses are obtained even from a terminal apparatus for which a decision has been made, the decision being that reacquisition of base station information from the terminal apparatus is not desired (such a terminal apparatus is, for example, the terminal apparatus 100-2 in FIG. 1). As described above, the more the number of measurement results for base station apparatuses is, the higher precision in the determination of the position of the terminal apparatus is. Therefore, terminal apparatuses to which to transmit a base station information report command may not be limited to terminal apparatuses for which a decision has been made in reacquisition decision processing in S106, the decision being that reacquisition of base station information from the terminal apparatus is desired; a base station information report command may be transmitted to all terminal apparatuses.

Although, in the sequence in FIG. 5, each base station apparatus 200 transmits a base station information report command, the control apparatus 300 may transmit a base station information report command through a base station apparatus as in S103. In particular, when a terminal apparatus to which to transmit a base station information report command is a terminal apparatus for which a decision has been made in reacquisition decision processing in S106, the decision being that reacquisition of base station information from the terminal apparatus is desired, it is preferable for the control apparatus 300, which recognizes a decision result in reacquisition decision processing, to transmit a base station information report command.

The terminal apparatus 100-1 receives the base station information report command and executes base station information report processing (S104). The terminal apparatus 100-1 transmits a base station information report to the control apparatus 300 (S110). The control apparatus 300 receives the base station information report and acquires base station information again.

As described above, in base station information acquisition processing in the first embodiment, if a measurement result for a neighboring base station apparatus is not included in received base station information, base station apparatuses are controlled so that the reception quality of a measurement-use signal is improved, after which base station information is acquired again. Since the reception quality of a measurement-use signal at terminal apparatuses is thereby improved, more terminal apparatuses receive a measurement-use signal from neighboring base station apparatuses with reception quality equal to or higher than the reference value. That is, the control apparatus 300 may acquire measurement results for more neighboring base station apparatuses from terminal apparatuses.

2. Reception Quality Improvement Processing

Reception quality improvement processing is described below. In reception quality improvement processing, the reception quality of a measurement-use signal transmitted from the neighboring base station apparatus is improved. Two examples of processing are described below as examples of reception quality improvement processing.

2.1 Assignment Stop Processing

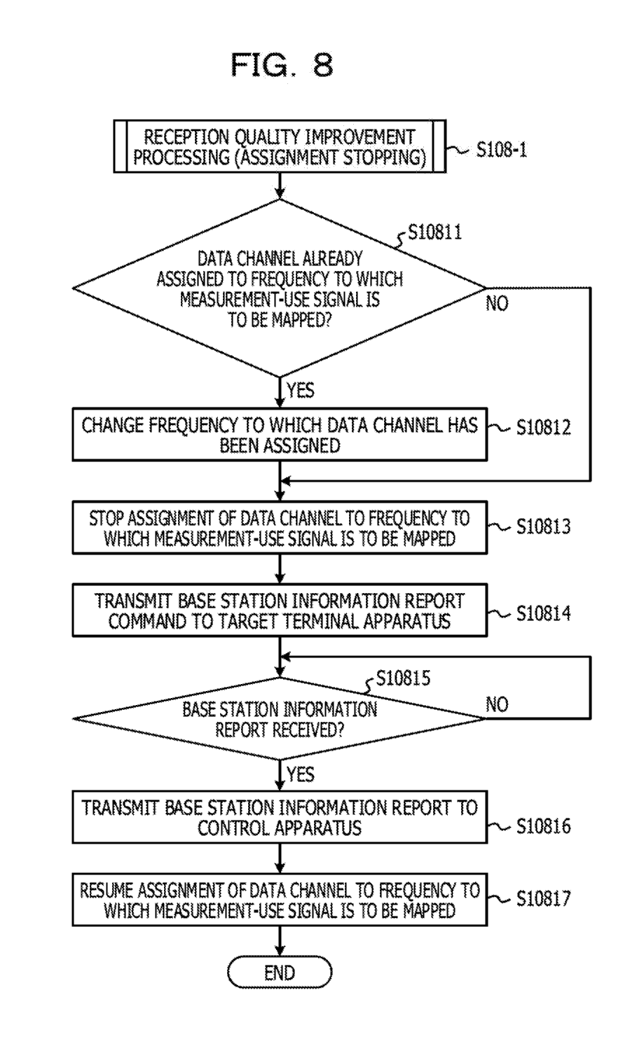

FIG. 8 illustrates an exemplary processing flowchart of assignment stop processing in reception quality improvement processing. In assignment stop processing, a base station apparatus does not assign a frequency resource to which a measurement-use signal is mapped, a frequency resource to which a data channel to be transmitted to a terminal apparatus is mapped.

As described above with reference to FIG. 5, when assignment stop processing is executed as reception quality improvement processing, a reception quality improvement command is transmitted to all base station apparatuses. Therefore, assignment stop processing is executed in the connection-in-progress base station apparatuses and neighboring base station apparatuses.

Assignment stop processing is described below with reference to FIG. 8.

In assignment stop processing, the base station apparatus 200 checks whether a data channel has been already assigned to a frequency resource to which a measurement-use signal is to be mapped (S10811). If a data channel has been already assigned (Yes in S10811), the base station apparatus 200 changes the frequency resource to which a data channel has been assigned (S10812).

The frequency resource may be changed to any frequency resource as long as the frequency resource is not the frequency resource to which a measurement-use signal is to be mapped. Therefore, the data channel already mapped to the frequency resource for a measurement-use signal shifts to a frequency resource other than the frequency resource to which a measurement-use signal is to be mapped. This suppresses the data channel from being assigned to a frequency resource to which a measurement-use signal is to be mapped. If a data channel has not been already assigned (No in S10811), the base station apparatus 200 does not perform processing (S10812) in which a frequency resource to which a data channel has been assigned is changed.

Next, the base station apparatus 200 stops the assignment of a data channel to the frequency resource to which a measurement-use signal is to be mapped (S10813). That is, while reception quality improvement processing is in progress, the base station apparatus 200 performs control of not assigning a frequency resource to which a measurement-use signal is to be mapped, a data channel or another signal. In some communication standards with which the communication system 10 complies, there is a case in which the assignment of a control signal fails to be stopped because a frequency resource to which the control signal is to be mapped is determined in advance. In this case, the base station apparatus 200 stops the assignment of a data channel that the base station apparatus 200 may assign.

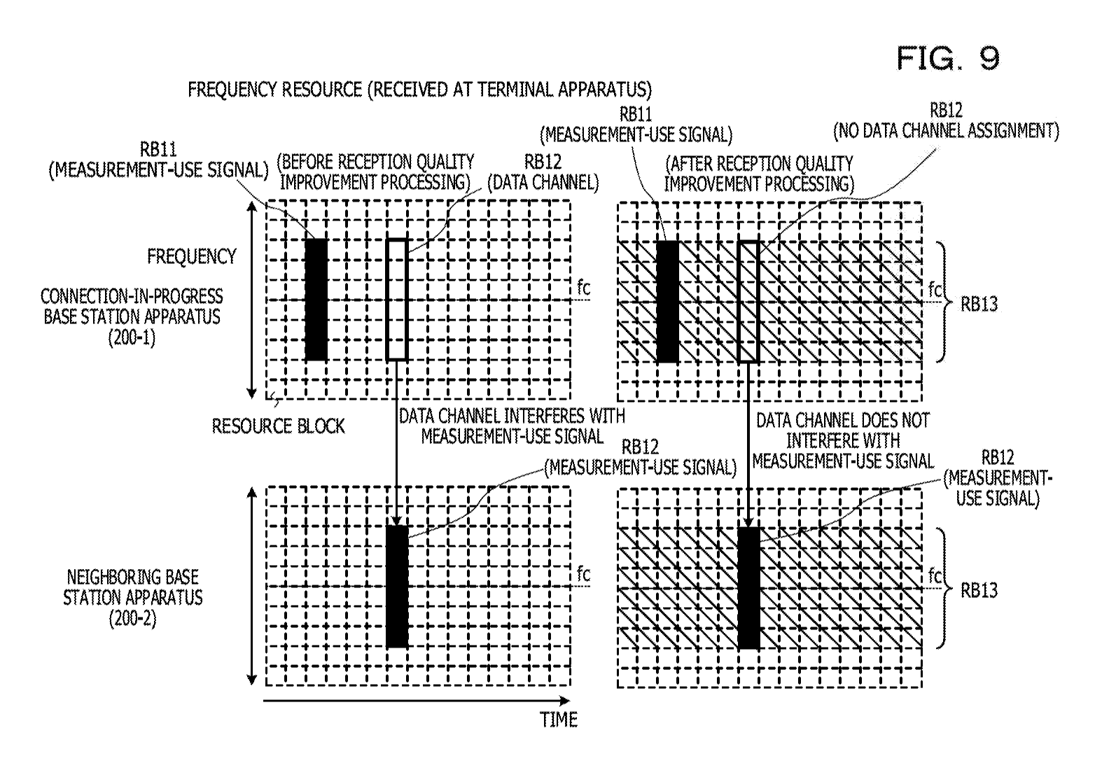

FIG. 9 illustrates exemplary radio resources received by the terminal apparatus 100-3. The radio resources in FIG. 9 are illustrated with time on the horizontal axis and frequency on the vertical axis. The frequency fc is the center frequency of the frequency resources to which a measurement-use signal is to be mapped. Each area enclosed by dotted lines is referred to as a resource block, and a set of a plurality of resource blocks is referred to as a resource block group.

The left side in FIG. 9 indicates a state taken before reception quality improvement processing is executed. A measurement-use signal transmitted by the connection-in-progress base station apparatus is mapped to a resource block group RB11, and a data channel is assigned to a resource block group other than the resource block group RB11. Similarly, a measurement-use signal transmitted by the neighboring base station apparatus is mapped to a resource block group RB12, and a data channel is assigned to a resource block group other than the resource block group RB12.

If the communication system 10 is a frequency division duplex (FDD) system that uses different frequency bands in transmission and reception, the communication system 10 does not execute time synchronization among base station apparatuses, so the timings of measurement-use signal in the time direction do not match. Therefore, the terminal apparatus receives measurement-use signals at different timings as indicated by RB11 and RB12 in FIG. 9.

Therefore, before reception quality improvement processing is executed, the data channel mapped to the resource block group RB12 by the connection-in-progress base station apparatus 200-1 interferes with the measurement-use signal mapped to the resource block group RB12 by the neighboring base station apparatus 200-2. In this case, depending on the degree of generated interference, the terminal apparatus fails to receive a measurement-use signal transmitted from the neighboring base station apparatus with reception quality equal to or higher than the reference value.

The right side in FIG. 9 indicates a state after reception quality improvement processing is executed. Each base station apparatus 200 stops the assignment of a measurement-use signal to a resource block group RB13, indicated by hatching, centered around the frequency fc and including the resource block groups RB11 and RB12 to which a measurement-use signal is to be mapped. That is, the connection-in-progress base station apparatus and the neighboring base station apparatus perform control of not mapping a data channel other than a measurement-use signal to the resource block groups RB11 and RB12 to which a measurement-use signal is to be mapped.

Accordingly, a data channel is not mapped to the resource block group RB12, to which a measurement-use signal from the connection-in-progress base station apparatus is to be mapped, so interference is not generated in a measurement-use signal that is transmitted from the neighboring base station apparatus and is to be mapped to the same resource block group RB12. Therefore, the terminal apparatus 100-3 may receive the measurement-use signal transmitted from the neighboring base station apparatus with reception quality equal to or higher than the reference value.

Referring again to the processing flowchart in FIG. 8, the base station apparatus 200 transmits a base station information report command to the terminal apparatus from which to acquire base station information again (S10814). If the base station apparatus 200 has received a base station information report from the terminal apparatus to which the base station information report command had been transmitted (Yes in S10815), the base station apparatus 200 transmits the base station information report to the control apparatus 300 (S10816). If the base station apparatus 200 has filed to receive a base station information report (No in S10815), the base station apparatus 200 waits until it receives a base station information report. If the base station apparatus 200 fails to receive a base station information report within a certain time, the base station apparatus 200 performs processing in S10817 and terminates the processing.

After having transmitted base station information to the control apparatus 300, the base station apparatus 200 resumes the assignment of a data channel to a frequency resource to which a measurement-use signal is to be mapped (S10817).

All base station apparatuses may not be included in the execution of assignment stop processing. For example, only a base station apparatus to which many terminal apparatuses are being connected and only a base station apparatus that transmits much downlink data may execute assignment stop processing. These base station apparatuses have a large amount of data to be mapped as data channels, so the probability is high that a data channel is assigned to a frequency resource as well to which a measurement-use signal is to be mapped. Therefore, if assignment stop processing is skipped for a base station apparatus for which the probability that a data channel is mapped to resource blocks to which a measurement-use signal is to be mapped is low even if assignment stop processing is not executed, extra processing executed by the base station apparatus may be suppressed.

As described above, in assignment stop processing, the assignment of a data channel to a frequency resource to which a measurement-use signal is to be mapped is stopped, so it is suppressed that interference is generated in a measurement-use signal transmitted from another base station apparatus. There may be a case in which, in spite of received power being equal to or higher than the power threshold, reception quality is equal to or lower than the reference value because the degree of interference is larger than the interference threshold, as with the terminal apparatus 100-3 located in the second area in FIG. 7B. In this case, assignment stop processing may be performed so as to lower only the degree of interference without lowering received power. This improves the probability that the terminal apparatus 100-3 located in the second area in FIG. 7B may receive a measurement-use signal from the neighboring base station apparatus with reception quality equal to or higher than the reference value, and thereby improves the probability that a measurement result for the neighboring base station apparatus is included in base station information.

2.2 Transmission Power Increase Processing

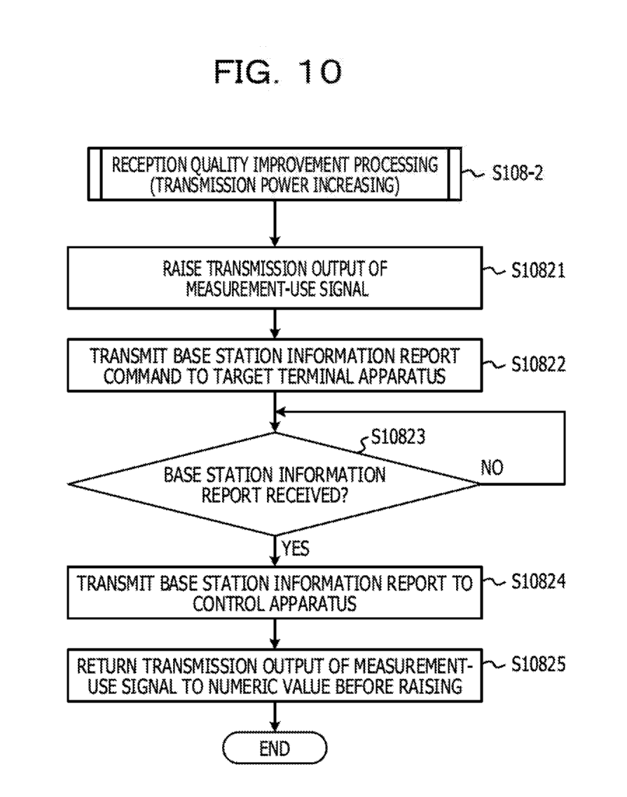

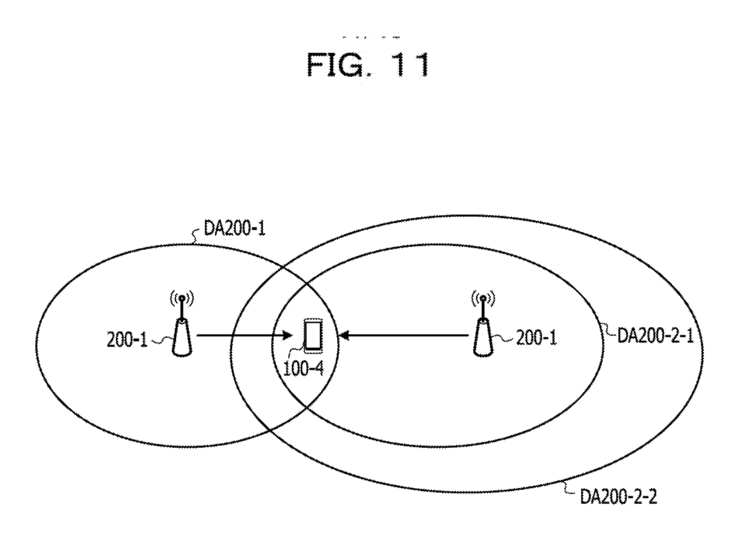

FIG. 10 illustrates an exemplary processing flowchart of transmission power increase processing in reception quality improvement processing. In transmission power increase processing, the transmission output power of a measurement-use signal transmitted from a base station apparatus is increased. The base station apparatus subject to transmission power increase processing is the neighboring base station apparatus. Transmission power increase processing is described below with reference to FIG. 10.

In transmission power increase processing, the base station apparatus 200 raises the transmission output power of a measurement-use signal (S10821). Thus, a range (referred to below as the measurement-use signal reception area) in which a terminal apparatus 100 may receive a measurement-use signal with received power equal to or higher than the reference value is expanded.

FIG. 11 illustrates an exemplary relationship between the terminal apparatus 100-4 and the measurement-use signal reception area before and after transmission power increase processing in the neighboring base station apparatuses. Before transmission power increase processing is executed, the terminal apparatus 100-4 is located in an area in which a measurement-use signal reception area DA200-1 and a measurement-use signal detection area DA200-2-1 overlap.

In FIG. 11, after transmission power increase processing has been executed, the measurement-use signal reception area DA200-2-1 for the base station apparatus 200-2 is expanded to the measurement-use signal reception area DA200-2-2. The received power of the measurement-use signal transmitted from the base station apparatus 200-2 and received at the terminal apparatus 100-4 has been increased when compared with the received power taken before transmission power increase processing had been executed. Therefore, since the received power of the measurement-use signal transmitted from the base station apparatus 200-2 is increased, when the degree of interference falls to or below the interference threshold, the reception quality of the measurement-use signal at the terminal apparatus 100-4 is increased to the reference value or higher. In this case, the terminal apparatus 100-4 includes a measurement result for the measurement-use signal from the base station apparatus 200-2, which is the neighboring base station apparatus, in base station information.

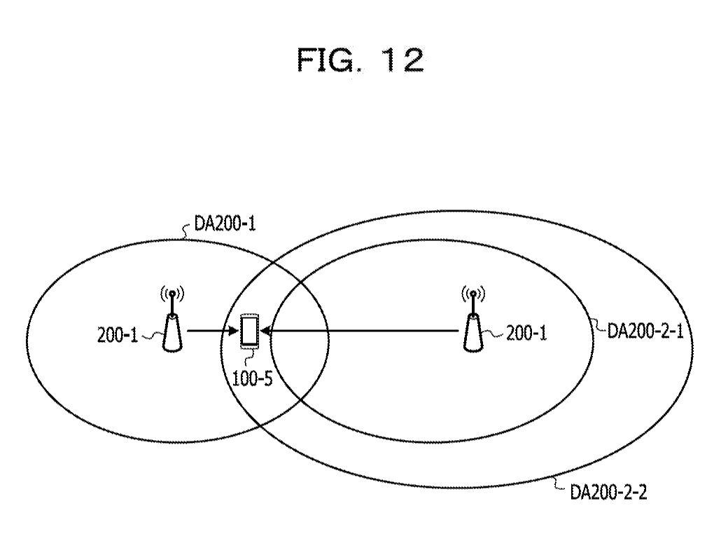

FIG. 12 illustrates an exemplary relationship between the terminal apparatus 100-5 and a cell before and after transmission power increase processing in the neighboring base station apparatus. Before transmission power increase processing is executed, the terminal apparatus 100-5 is located in an area that is in the measurement-use signal reception area DA200-1 but is outside the measurement-use signal reception area DA200-2-1.

In FIG. 12, after transmission power increase processing has been executed, the measurement-use signal reception area DA200-2-1 for the neighboring base station apparatus 200-2 is expanded to the measurement-use signal reception area DA200-2-2. Before transmission power increase processing has been executed, the terminal apparatus 100-5 failed to receive a measurement-use signal from the base station apparatus 200-2 due to low received power, but now the terminal apparatus 100-5 may receive a measurement-use signal with received power equal to or higher than the power threshold. If the degree of interference is lower than the interference threshold, the terminal apparatus 100-5 receives a measurement-use signal from the base station apparatus 200-2 with reception quality equal to or higher than the reference value. In this case, the terminal apparatus 100-5 includes a measurement result for the measurement-use signal from the neighboring base station apparatus 200-2 in base station information.

In FIGS. 11 and 12, a measurement-use signal reception area and a cell are different areas. That is, in transmission power increase processing executed by the control apparatus 300, a measurement-use signal reception area is expanded but a cell is not expanded. Thus, it is possible to suppress the occurrence of a handover or the like that is otherwise generated as a result of, for example, expanding a cell. If, for example, the occurrence of a handover may be suppressed by other processing or the occurrence of a handover is not a problem, a measurement-use signal reception area and a cell may be the same area

Referring again to the processing flowchart in FIG. 10, the base station apparatus 200 transmits a base station information report command to the terminal apparatus from which to acquire base station information again (S10822). If the base station apparatus 200 has received a base station information report from the terminal apparatus to which the base station information report command had been transmitted (Yes in S10823), the base station apparatus 200 transmits the base station information report to the control apparatus 300 (S10824). After having transmitted the base station information report to the control apparatus 300, the base station apparatus 200 returns the transmission output power of the measurement-use signal to the transmission output power taken before the execution of transmission power increase processing had been executed (S10825). If the base station apparatus 200 has not received a base station information report (No in S10823), the base station apparatus 200 waits until it receives a base station information report.

In transmission power increase processing, the transmission output power of a measurement-use signal from the neighboring base station apparatus is increased to lower the degree of interference (influence of interference) in a measurement-use signal at the terminal apparatus 100-3 located in the second area and to raise the received power of a measurement-use signal at the terminal apparatus 100-1 located in the first area. This improves the probability that the terminal apparatus receives a measurement-use signal from the neighboring base station apparatus with reception quality equal to or higher than the reference value, and thereby improves the probability that a measurement result for the neighboring base station apparatus is included in base station information.

3. Received Power Estimation Processing

Referring again to the sequence in FIG. 5, received power estimation processing is described below.

After having received a base station information report in S110, the control apparatus 300 executes reacquisition decision processing (S111) as in S106. However, even if the control apparatus 300 decides that the reacquisition of base station information is preferable (Yes in S111), the control apparatus 300 does not acquire base station information again. This is because quality improvement processing had been already executed and base station information has been acquired again. Therefore, if the control apparatus 300 decides that the reacquisition of base station information is preferable (Yes in S111), the control apparatus 300 executes received power estimation processing instead (S112).

In received power estimation processing, a measurement result (received power) that has failed to be acquired, the measurement result being for the neighboring base station apparatus, is estimated. Since the control apparatus 300 fails to receive a measurement result for the neighboring base station apparatus in spite of having executed reception quality improvement processing, the control apparatus 300 decides that the terminal apparatus is located in the first area (see FIG. 7A).

If the terminal apparatus 100 is located near the center of the cell of the connection-in-progress base station apparatus in the first area, the received power of a measurement-use signal transmitted from the connection-in-progress base station apparatus is very high. Therefore, even if the cell size is increased by raising the transmission output power of the neighboring base station apparatus, the probability that interference is generated in the terminal apparatus or a handover to the neighboring base station apparatus occurs, for example, is low. That is, even if the cell size is changed, the terminal apparatus 100 located near the center of the cell as described above is less likely to be affected.

If, however, the terminal apparatus 100 is located at an end of the cell of the connection-in-progress base station apparatus in the first area, when the cell of the neighboring base station apparatus is expanded, the probability that interference is generated in the terminal apparatus or a handover to the neighboring base station apparatus occurs is high. Therefore, if a terminal apparatus 100 is located at an end of a cell, it is desirable for the control apparatus 300 to determine the size of the cell of the neighboring base station apparatus in consideration of an influence on the terminal apparatus 100.

In view of this, under the assumption that the terminal apparatus 100 is located on the boundary between the first area and the second area, that is, located in the cell of the connection-in-progress base station apparatus and near an end of the cell of the neighboring base station apparatus, the control apparatus 300 estimates the received power of a measurement-use signal transmitted from the neighboring base station apparatus and received at the terminal apparatus 100. When the control apparatus 300 estimates received power at the terminal apparatus under this assumption and controls transmission from the base station apparatus based on the estimated received power, it may be expected that at least the state of a terminal apparatus may be improved at a position at which the terminal apparatus is largely affected by the size of the neighboring cell. Thus, in received power estimation processing, if the position of a terminal apparatus is unclear in the first area, it is assumed that, to prevent an unexpected handover to the neighboring base station apparatus, the terminal apparatus is located at a position at which the terminal apparatus is largely affected when the size of the neighboring cell is changed (at a position near an end of the neighboring cell in the first area).

Received power estimation processing includes, for example, processing (referred to below as power-threshold-based estimation processing) to calculate received power based on the power threshold and processing (referred to below as local-cell-based estimation processing) to calculate received power from the received power of a measurement-use signal transmitted from the connection-in-progress base apparatus.

3.1 Power-Threshold-Based Estimation Processing

In power-threshold-based estimation processing, it is estimated that the received power at a terminal apparatus is equal to the power threshold of a measurement-use signal transmitted from a neighboring base station apparatus, under the assumption that the terminal apparatus is located near an end of the neighboring cell. Since a terminal apparatus in the first area is located outside the cell of the neighboring base station apparatus, the received power of a measurement-use signal from the neighboring base station apparatus is lower than the power threshold. However, the received power at a terminal apparatus located on the boundary of the cell of the neighboring base station apparatus at its cell end in the cell of the connection-in-progress base station apparatus is the power threshold, which is the minimum received power. Therefore, the control apparatus 300 estimates that the received power of a measurement-use signal from the neighboring base station apparatus is equal to the power threshold, which is the minimum value that may be taken as received power.

The measurement-use signal is, for example, a synchronization signal used to establish synchronization with a base station apparatus. If the measurement-use signal is a synchronization signal, the terminal apparatus searches for a synchronization signal, receives the searched-for synchronization signal, and measures the received power of the received synchronization signal. The terminal apparatus handles the measured received power of the synchronization signal as the received power of the measurement-use signal.

Alternatively, the measurement-use signal is, for example, a reference signal used to measure reception quality. If the measurement-use signal is a reference signal, the terminal apparatus searches for a synchronization signal, receives the searched-for synchronization signal, and establishes synchronization with the base station apparatus that has transmitted the synchronization signal, according to the received synchronization signal. The terminal apparatus then extracts the reference signal from the synchronized radio wave and measures the received power of the received reference signal. The terminal apparatus handles the measured received power of the reference signal as the received power of the measurement-use signal.

In addition, if the measurement-use signal is a reference signal, the received power of the measurement-use signal may be calculated (estimated) from the received power of a synchronization signal without measuring the received power of the reference signal. There is a case in which a terminal apparatus transmits a reference signal and a synchronization signal with different transmission powers. In this case, the control apparatus calculates the received power of the reference signal from the received power of the synchronization signal by estimating a difference between the transmission power of the reference signal and the transmission power of the synchronization signal as a difference between the received power of the reference signal and the received power of the synchronization signal.

When a terminal apparatus transmits the received power of a synchronization signal as base station information, the control apparatus calculates the received power of the reference signal from the received power of the received synchronization signal. The control apparatus calculates a differential power value by subtracting the transmission power of the reference signal from the transmission power of the synchronization signal at the base station apparatus, and calculates the received power of the reference signal by subtracting the calculated differential power value from the received power of the received synchronization signal. Processing to calculate the received power of the reference signal from the received power of the synchronization signal may be executed in the terminal apparatus.

In power-threshold-based estimation processing, if the measurement-use signal is a reference signal and a signal to be measured by a terminal apparatus is a synchronization signal, the control apparatus 300 estimates a power value obtained by subtracting the differential power value descried above from the power threshold as the received power of the measurement-use signal.

3.2 Local-Cell-Based Estimation Processing

In local-cell-based estimation processing, the received power of a measurement-use signal transmitted from a neighboring base station apparatus is estimated from the received power of a measurement-use signal transmitted from a connection-in-progress base station apparatus.

First, since the received power of a measurement-use signal from the neighboring base station apparatus is lower than the received power of a measurement-use signal from the connection-in-progress base station apparatus, the control apparatus 300 estimates a value obtained by subtracting a predetermined fixed value from the received power of the measurement-use signal from the connection-in-progress base station apparatus as the received power of the measurement-use signal from the neighboring base station apparatus. Within a range in which the estimated value of the received power of a measurement-use signal from the neighboring base station apparatus does not exceed the power threshold, an adequately large numeric value is sufficient as the fixed value. The fixed value is calculated from, for example, data obtained in an experiment or simulation and is embedded in a program in advance.

Second, the control apparatus 300 may store differences in received power between the connection-in-progress base station apparatus and the neighboring base station apparatus if the neighboring base station apparatus is indicated in base station information, starting from when, for example, the operation of the communication system was started, and may use the stored maximum difference in received power as the fixed value. The maximum difference in received power is subtracted as the fixed value under the assumption that the terminal apparatus is located at a position at which received power of the measurement-use signal from the neighboring base station apparatus is minimized, that is, at an end of the cell of the neighboring base station apparatus. Therefore, under the assumption that the terminal apparatus is located at an end of the cell of the neighboring base station apparatus, the control apparatus 300 may estimate the received power of the measurement-use signal from the neighboring base station apparatus by using the stored maximum difference in received power as the fixed value.

Since power-threshold-based estimation processing is such that a fixed value is used in estimation, calculation in estimation is simple, so a load on the control apparatus 300 in calculation processing is small.

By contrast, in local-cell-based estimation processing, when an appropriate fixed value is set, a precise estimation may be performed. In addition, when the stored maximum difference in received power is used as the fixed value, the fixed value is a value based on measured values in an actual communication system is obtained, so a more precise estimation may be performed.

If a measurement result for a neighboring base station apparatus is not included in base station information transmitted from a terminal apparatus even after reception quality improvement processing has been executed, the control apparatus 300 may decide that the terminal apparatus is located in the first area. If reception quality improvement processing is not performed, however, the control apparatus 300 fails to determine whether a terminal apparatus from which a measurement result for a neighboring base station apparatus fails to be acquired is located in the first area or second area.

In the first embodiment, however, the control apparatus 300 acquires a measurement result for a neighboring base station apparatus from a terminal apparatus located in the second area in reception quality improvement processing. Therefore, if a measurement result for a neighboring base station apparatus fails to be acquired from a terminal apparatus even after reception quality improvement processing has been executed, the control apparatus 300 may decide that the terminal apparatus is located in the first area.

Therefore, when estimating the position of a terminal apparatus, the control apparatus 300 may exclude the possibility that a terminal apparatus from which a measurement result for a neighboring base station apparatus failed to be acquired is located in the second area. This enables transmission control for a base station apparatus to be executed with higher precision.

4. Base Station Transmission Control Processing

Referring again to the sequence in FIG. 5, the control apparatus 300 executes base station apparatus transmission control processing (S113) based on received power at the terminal apparatus, the received power being included in base station information acquired in S105 and S110 and to received power at the terminal apparatus, the received power having been estimated in received power estimation processing in S112.

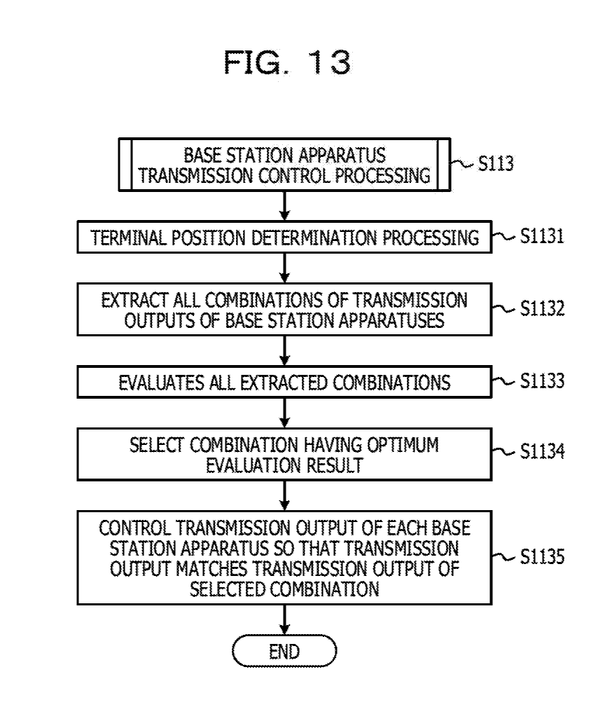

FIG. 13 illustrates an exemplary processing flowchart of base station transmission control processing. In base station transmission control processing, the control apparatus 300 executes terminal position determination processing (S1131). In terminal position determination processing in S1131, the control apparatus 300 calculates a path loss between a connection-in-progress base station apparatus and a neighboring base station apparatus for all terminal apparatuses.

The path loss is a numeric value that indicates the amount of attenuation caused in a radio wave transmitted from a base station apparatus and received at a terminal apparatus. The path loss is, for example, a ratio of received power with which a terminal apparatus receives a radio wave to a transmission output with which a base station apparatus transmits the radio wave. By calculating a path loss between each terminal apparatus and its relevant base station apparatus, the control apparatus 300 may estimate a distance in terms of a radio wave between the terminal apparatus and the base station apparatus and thereby may estimate the position of the terminal apparatus.

Next, the control apparatus 300 extracts all combinations of the transmission output powers of base station apparatuses (S1132). For example, the control apparatus 300 extracts all combinations in a case in which transmission output powers of base station apparatuses from the minimum transmission output power to the maximum transmission output power are changed in one-decibel units (dB).

The control apparatus 300 evaluates all the extracted combinations (S1133). The control apparatus 300 determines whether the each terminal apparatus is located in the first area or second area, for each of the extracted combinations, when the control apparatus 300 controls the base station apparatuses so that the transmission powers of the base station apparatuses are transmission powers indicating the extracted combination. According to the predicated degree of interference (such as, for example, an SINR) in each terminal apparatus or a predicted throughput of each terminal apparatus, the control apparatus 300 performs an evaluation. For example, the control apparatus 300 takes the average of the predicted throughputs of all terminal apparatuses as the evaluated value.

The control apparatus 300 selects a combination having an optimum evaluation result from the evaluation results of all combinations (S1134). For example, the control apparatus 300 selects a combination having the highest average of the predicted throughputs of all terminal apparatuses as the combination having an optimum evaluation result.

The control apparatus 300 then controls the transmission output power of each base station apparatus so that its transmission output power matches the transmission output power of the selected combination (S1135) to increase or decrease the transmission output power of the base station apparatus.

As described above, the control apparatus 300 determines the position of a terminal apparatus based on acquired measurements result for base station apparatuses and the estimated received power. The control apparatus 300 then determines a cell size according to the determined position of the terminal apparatus and controls the transmission output powers of the base station apparatuses. In the first embodiment, the control apparatus 300 increases the number of terminal apparatuses from which a measurement result for a neighboring base station apparatus is acquired by performing reception quality improvement processing. Thus, the control apparatus 300 may control transmission output powers in base station apparatus transmission control processing so that an appropriate cell size is obtained, according to neighboring base station information transmitted from the terminal apparatus located at an end of the cell of the connection-in-progress base station apparatus.

In reception quality improvement processing, when the control apparatus 300 estimates that a terminal apparatus from which neighboring base station information fails to be received is located at a position at which the terminal apparatus is largely affected by the cell size of the neighboring base station apparatus, the control apparatus 300 may estimate a cell size with this type of terminal apparatuses taken into consideration.

### Second Embodiment

In a second embodiment, if a measurement result for a neighboring base station apparatus is not included in base station information and the condition that the received power of a connection-in-progress base station apparatus is higher than the reference power is not satisfied, the control apparatus performs reception quality improvement processing. When the received power of a connection-in-progress base station apparatus is higher than the reference power, this indicates that, for example, the terminal apparatus is located near the connection-in-progress base station apparatus and is not located at an end of the cell (an end of the communication area). If the terminal apparatus is not located at an end of the cell but is located near the center of the cell (near the connection-in-progress base station apparatus), the control apparatus performs neither quality improvement processing nor reacquisition processing.

Examples of the structures of the control apparatus, base station apparatus, and terminal apparatus in the second embodiment are the same as in the first embodiment.

Base Station Information Acquisition Processing

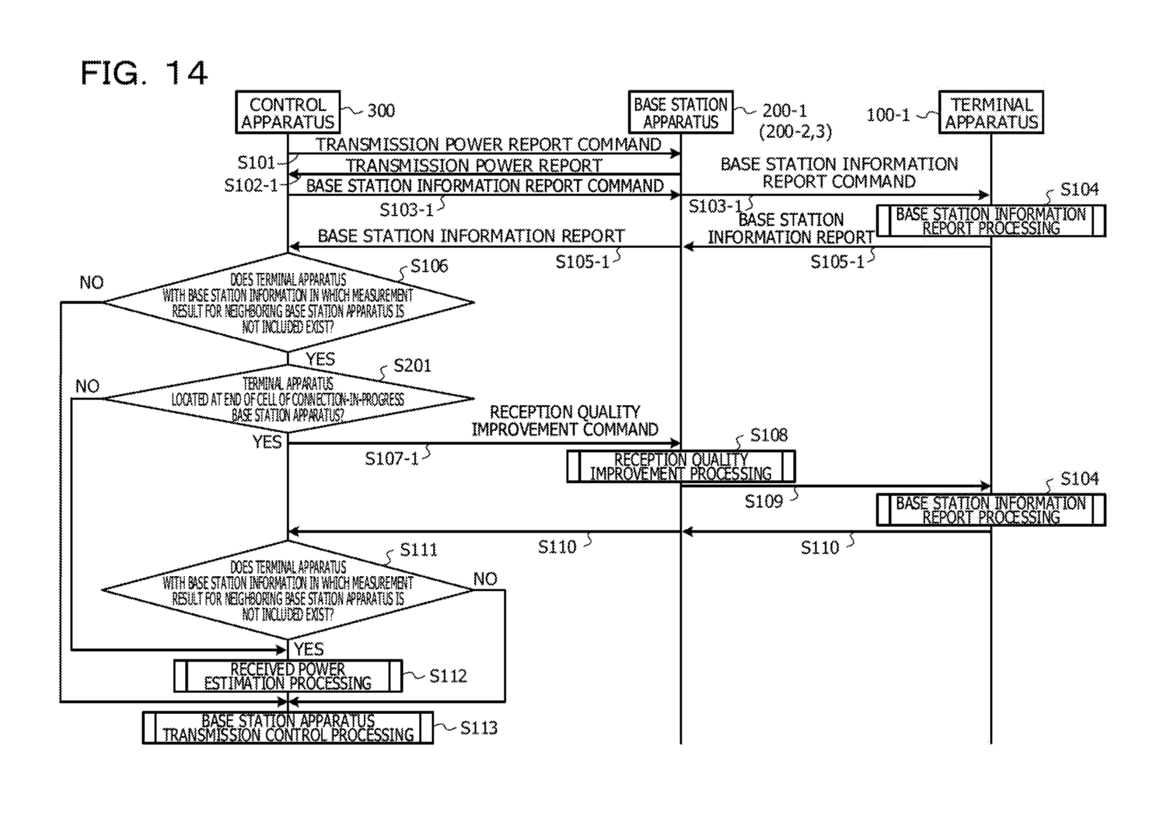

FIG. 14 illustrates an exemplary sequence of base station control processing. Base station information acquisition processing in base station apparatus control processing is described below with reference to FIG. 14. In FIG. 14, the base station apparatuses 200-1 and 200-3 and terminal apparatus 100-2 are omitted.

Processing from when the control apparatus 300 transmits a transmission power report command (S101) until the control apparatus 300 decides whether there is a terminal apparatus that had transmitted base station information in which a measurement result for a neighboring base station apparatus is not included in the received base station information (S106) is the same as in the sequence in FIG. 5.

If the control apparatus 300 decides that there is a terminal apparatus that had transmitted base station information in which a measurement result for a neighboring base station apparatus is not included in the received base station information (Yes in S106), the control apparatus 300 further decides whether the terminal apparatus is located at an end of the cell of the connection-in-progress base station apparatus (S201). If, for example, the received power of the connection-in-progress base station apparatus, the received power being included in base station information, is lower than the reference power, the control apparatus 300 decides that the terminal apparatus is located at an end of the cell. The reference power is received power at a position near the connection-in-progress base station apparatus or on the boundary of the cell of the neighboring base station apparatus at its cell end in the cell of the connection-in-progress base station apparatus. The reference power is, for example, the received power of a measurement-use signal, transmitted from the connection-in-progress base station apparatus, at the terminal apparatus when the terminal apparatus is located apart from the base station apparatus by a certain distance (or distance in terms of a radio wave). The reference power indicates that the terminal apparatus is in the communication area of the connection-in-progress base station apparatus and is located near the connection-in-progress base station apparatus, that is, at a position that is not an end, of the communication area, that is apart from by a certain distance or more.

The control apparatus 300 may acquire a quality index that indicates the degree of quality with which a terminal apparatus may receive a radio wave transmitted from a connection-in-progress base station apparatus. Examples of the quality index include the reference signal received quality (RSRQ) and channel quality indicator (CQI) of a connection-in-progress base station apparatus. If the value of the acquired quality index is lower than the reference quality, the control apparatus 300 decides that the relevant terminal apparatus is located at an end of the cell. If the received power is lower than the reference power and the value of the acquired quality index is lower than the reference quality, the control apparatus 300 may decide that the terminal apparatus is located at an end of the cell, based on both the received power from the connection-in-progress base station apparatus and the quality index.

If the control apparatus 300 decides that the terminal apparatus is located at an end of the cell (Yes in S201), the control apparatus 300 transmits a reception quality improvement command to the target base station apparatus.

If the control apparatus 300 decides that the terminal apparatus is not located at an end of the cell (No in S201), the control apparatus 300 executes neither reception quality improvement processing nor the reacquisition of base station information but executes received power estimation processing (S112). Subsequent processing is the same as in the sequence in FIG. 5.

As described above, in the second embodiment, if a terminal apparatus that transmits base station information in which a measurement result for a neighboring base station apparatus is not included is not located at an end of the cell of the connection-in-progress base station apparatus, the control apparatus executes neither reception quality improvement processing nor the reacquisition of base station information.

When a terminal apparatus is not located at an end of the cell of the connection-in-progress base station apparatus, this indicates that the terminal apparatus is located near the center of the connection-in-progress base station apparatus, so the possibility is high that the terminal apparatus is located in the first area, in which there is no overlap of cells. In this case, even if reception quality improvement command is executed to lower the degree of interference in a measurement-use signal from the neighboring base station apparatus, the probability is low that the terminal apparatus may receive the measurement-use signal with reception quality equal to or higher than the reference value. Therefore, when, based on the received base station information, power to be received is estimated and base station transmission control processing is executed, without executing reception quality improvement processing, it is possible to suppress a resource reduction and an increase in interference that may otherwise temporarily occur as a result of the execution of reception quality improvement processing.

### Third Embodiment

In a third embodiment, reception quality improvement processing includes assignment stop processing and transmission output increase processing. If base station information does not satisfy the predetermined condition, the control apparatus first executes assignment stop processing and receives base station information again from the terminal apparatus. If the base station information received again still does not satisfy the predetermined condition, the control apparatus executes transmission output increase processing.

Example of Control Apparatus

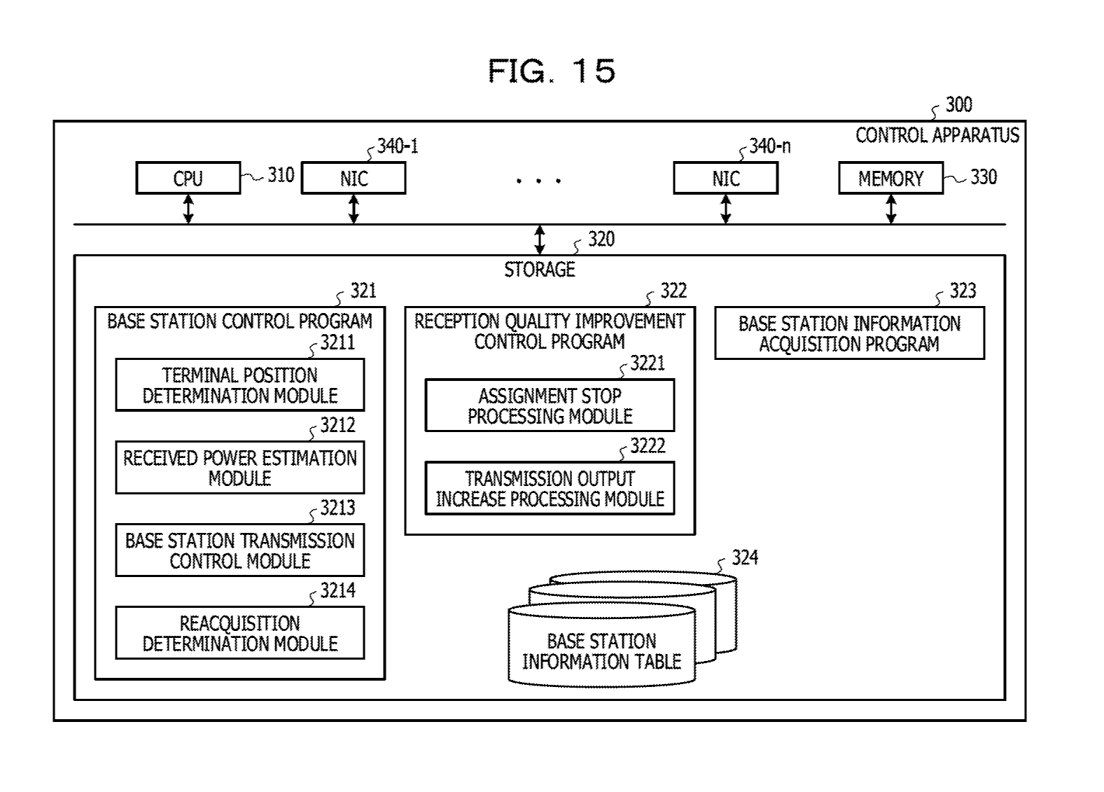

FIG. 15 illustrates an exemplary structure of the control apparatus 300. The storage 320 in the control apparatus 300 stores the reception quality improvement control program 322. The reception quality improvement control program 322 has an assignment stop processing module 3221 and a transmission output increase processing module 3222.

The CPU 310 executes the reception quality improvement control program 322 to construct a control unit and implement reception quality improvement processing. In reception quality improvement processing, a base station apparatus is caused to execute processing to improve the reception quality of a measurement-use signal from a neighboring base station apparatus. In reception quality improvement processing, the control apparatus 300 causes a base station apparatus to selectively execute assignment stop processing and transmission output increase processing. If the reacquisition of base station information has not been executed, the control apparatus 300 causes the base station apparatus to execute assignment stop processing. If the reacquisition of base station information has been executed, the control apparatus 300 causes the base station apparatus to execute transmission power increase processing. The control apparatus 300 stores, in an internal memory, information as to whether the reacquisition of base station information has been executed, and manages the information.

Exemplary Structure of Base Station Apparatus

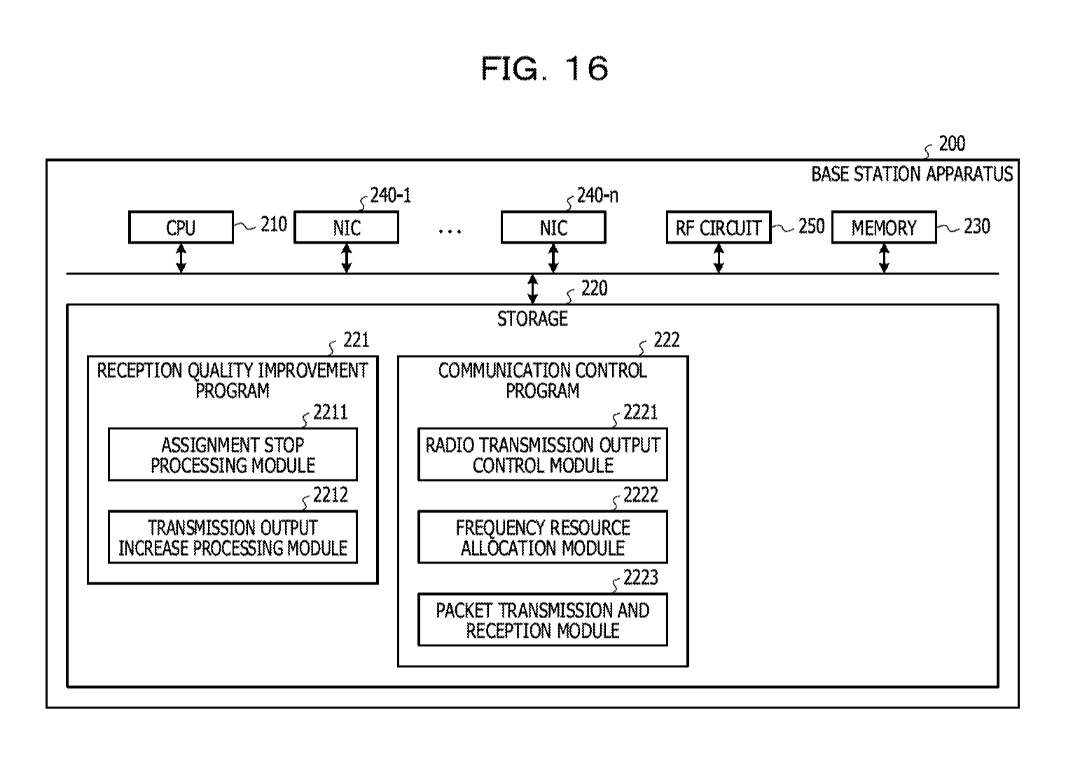

FIG. 16 illustrates an exemplary structure of the base station apparatus 200. The storage 220 in the base station apparatus 200 stores the reception quality improvement program 221. The reception quality improvement program 221 has an assignment stop processing module 2211 and a transmission output increase processing module 2212.

The CPU 210 executes the reception quality improvement program 221 to construct a reception quality improvement processing unit and implement reception quality improvement processing. In reception quality improvement processing, assignment stop processing or transmission output increase processing is executed in response to a command from the control apparatus 300.

Base Station Information Acquisition Processing

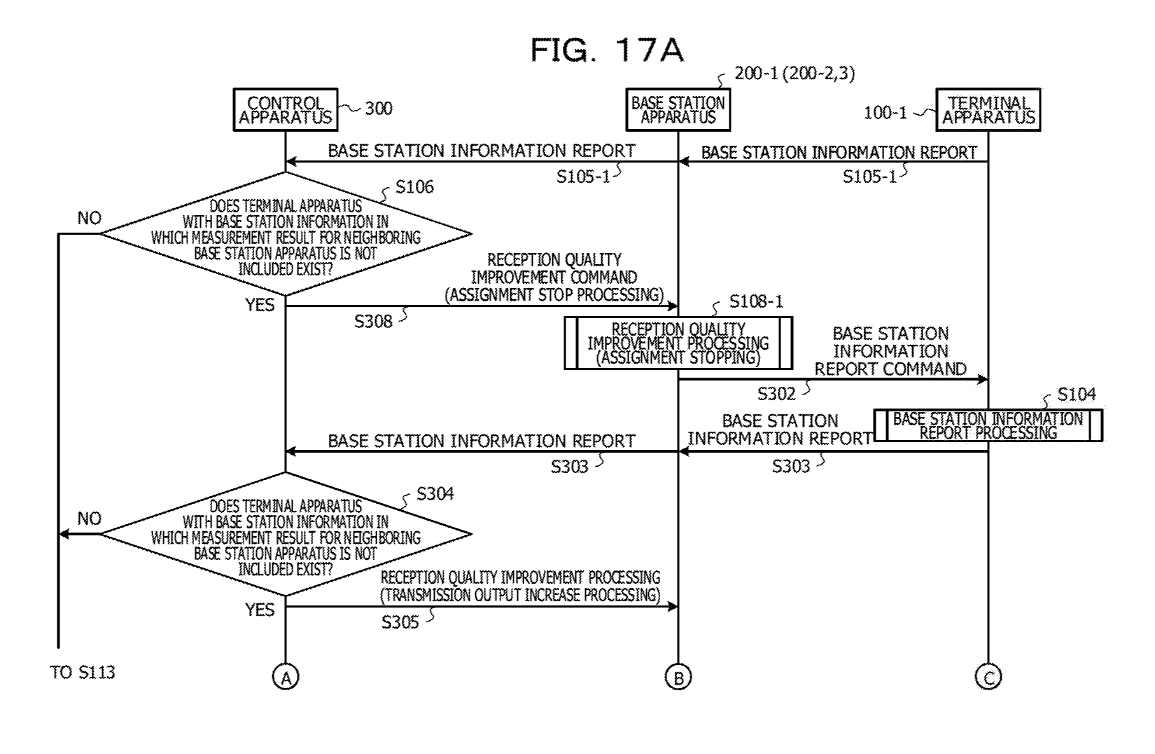

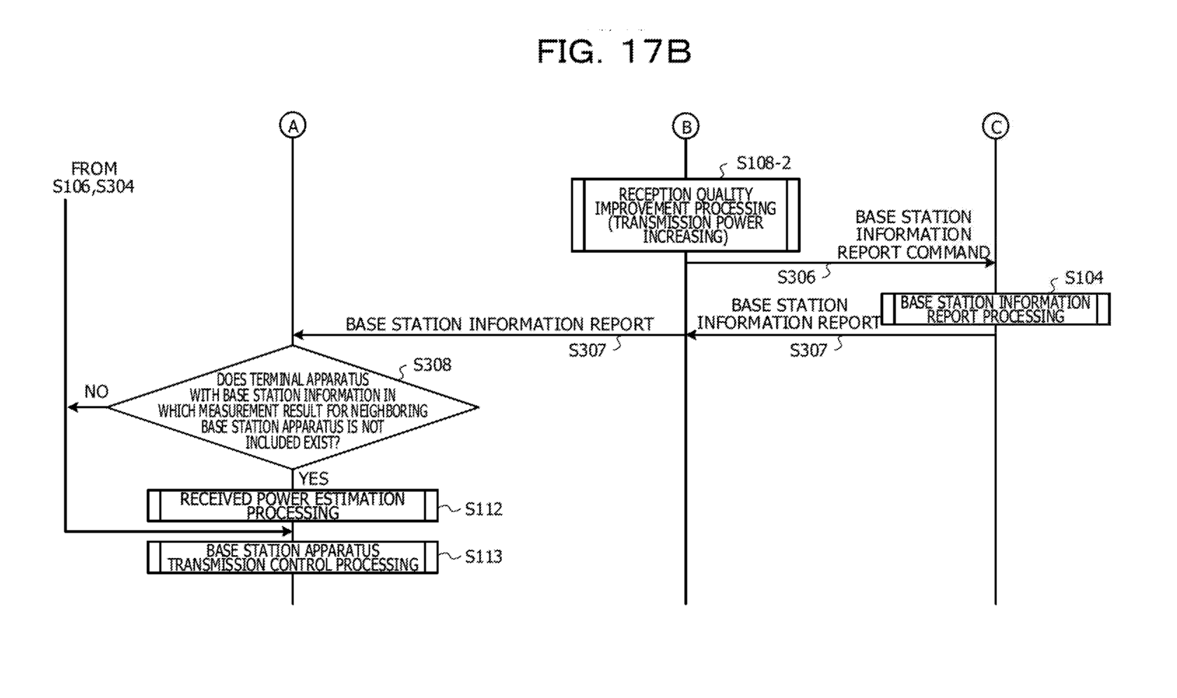

FIGS. 17A and 17B illustrates an exemplary sequence of base station control processing. Base station information acquisition processing in base station control processing is described below with reference to FIGS. 17A and 17B. In FIGS. 17A and 17B, the base station apparatuses 200-2 and 200-3 and terminal apparatus 100-2 are omitted. Processing in the sequence in FIG. 5 from the transmission of a transmission power report command in S101 to the reception of a transmission power report from individual terminal apparatuses in S102-2 is also omitted.

The control apparatus 300 receives a base station information report (S105-1) and acquires base station information, after which the control apparatus 300 checks whether there is a terminal apparatus from which a measurement result for a neighboring base station apparatus has failed to be acquired (S106).

If there is a terminal apparatus from which a measurement result for a neighboring base station apparatus has failed to be acquired (Yes in S106), the control apparatus 300 decides to acquire base station information again from the terminal apparatus and transmits a reception quality improvement command to the base station apparatuses 200-1 to 200-3 (S301). The reception quality improvement command transmitted to the base station apparatuses causes them to execute assignment stop processing. Upon the reception of the reception quality improvement command, the base station apparatuses 200-1 to 200-3 execute reception quality improvement processing (S108-1). Reception quality improvement processing executed by the base station apparatuses is assignment stop processing commanded by the control apparatus 300. The base station apparatuses 200-1 to 200-3 execute assignment stop processing, and if the terminal apparatus from which to acquire base station information again is being connected, transmit a base station information report command to the terminal apparatus (S302).

Upon the reception of the base station information report command, the terminal apparatus 100-1 executes base station information report processing (S104), after which the terminal apparatus 100-1 transmits a base station information report to the control apparatus 300 through the base station apparatus 200-1, which is a connection-in-progress base station apparatus (S303).

The control apparatus 300 receives the base station information report (S303) and acquires base station information again, after which the control apparatus 300 executes reacquisition decision processing again and checks whether there is a terminal apparatus from which a measurement result for a neighboring base station apparatus has failed to be acquired (S304).

If there is a terminal apparatus from which a measurement result for a neighboring base station apparatus has failed to be acquired (Yes in S304), the control apparatus 300 decides to acquire base station information from the terminal apparatus for a third time and transmits a reception quality improvement command to the base station apparatuses 200-1 to 200-3 (S305). The reception quality improvement command transmitted to the base station apparatuses causes the base station apparatuses to execute transmission output increase processing. Upon the reception of the reception quality improvement command, the base station apparatuses 200-1 to 200-3 execute reception quality improvement processing (S108-2). Reception quality improvement processing executed by the base station apparatuses is transmission output increase processing commanded by the control apparatus 300. The base station apparatuses 200-1 to 200-3 execute transmission output increase processing, and if a terminal apparatus from which to acquire base station information for a third time is being connected, transmit a base station information report command to the terminal apparatus (S306).

Upon the reception of the base station information report command, the terminal apparatus 100-1 executes base station information report processing (S104), after which the terminal apparatus 100-1 transmits a base station information report to the control apparatus 300 through the base station apparatus 200-1, which is a connection-in-progress base station apparatus (S307).

The control apparatus 300 receives the base station information report (S307) and acquires base station information for a third time, after which the control apparatus 300 executes reacquisition decision processing for a third time and checks whether there is a terminal apparatus from which a measurement result for a neighboring base station apparatus has failed to be acquired (S308).

If there is a terminal apparatus from which a measurement result for a neighboring base station apparatus has failed to be acquired (Yes in S308), the control apparatus 300 does not execute further acquisition of base station information, but executes received power estimation processing (S112), after which the control apparatus 300 executes base station apparatus transmission control processing (S113).

In the third embodiment, if there is a terminal apparatus from which a measurement result for a neighboring base station apparatus has failed to be acquired, the control apparatus 300 executes reception quality improvement processing and base station information acquisition again. In reception quality improvement processing, assignment stop processing is first executed. If a measurement result for a neighboring base station apparatus still fails to be acquired, transmission output increase processing is then executed. In assignment stop processing, interference in a measurement-use signal transmitted to the terminal apparatus located in the second area in FIG. 7A is reduced so that a measurement result for a neighboring base station apparatus is included in base station information transmitted from the terminal apparatus. If a measurement result for a neighboring base station apparatus still fails to be acquired from the terminal apparatus even after the execution of assignment stop processing, the reason why a measurement result for a neighboring base station apparatus is not included in base station information may not be that the degree of interference is higher than the interference threshold, but may be that the received power is lower than the power threshold. Thus, the control apparatus 300 executes transmission output increase processing to raise the received power of a measurement-use signal so that the received power is controlled to the power threshold or higher. Thus, a measurement result for a neighboring base station apparatus that is failed to be acquired by executing assignment stop processing alone may be acquired by executing transmission output increase processing for more neighboring base station apparatuses.

The assignment stop processing is processing to stop the assignment of a data channel to a frequency resource at which a measurement-use signal is transmitted. During the execution of assignment stop processing, therefore, some frequency resources may not be used for data channels, and available frequency resources are decreased. By contrast, transmission output increase processing is processing to raise the transmission output power of a measurement-use signal transmitted from a neighboring base station apparatus. In transmission output increase processing, therefore, the radio wave strength of a measurement-use signal is increased and a distance over which the measurement-use signal is transmitted is also increased, and the measurement-use signal may cause interference in communication by other terminal apparatuses in which interference has not been generated before transmission output increase processing had been executed.

In assignment stop processing, available frequency resources are only temporarily decreased and there is almost no influence on other terminal apparatuses that are in communication. In transmission output increase processing, however, additional interference sources may be increased in communication by other terminal apparatuses. Therefore, since transmission output increase processing largely affects other terminal apparatuses when compared with assignment stop processing, it is preferable for transmission output increase processing not to be executed, if possible.

In the third embodiment, therefore, the control apparatus 300 first executes assignment stop processing, which causes relatively small influences on other terminal apparatuses, to acquire base station information again. If a measurement result for a neighboring base station apparatus still fails to be acquired even in the reacquisition, the control apparatus 300 executes transmission output increase processing, which causes relatively large influences on other terminal apparatuses, to acquire base station information for a third time.

As described above, the control apparatus 300 first execute assignment stop processing, which causes relatively small influences, to try to acquire a measurement result for a neighboring base station apparatus while suppressing influences on other terminal apparatuses as much as possible. Only if the control apparatus 300 still fails to acquire a measurement result for a neighboring base station apparatus, the control apparatus 300 executes transmission output increase processing, which causes relative large influences. This enables measurement results for neighboring base station apparatuses to be acquired easily while influences caused on other terminal apparatuses by executing quality improvement processing are suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus coupled to a plurality of base station apparatuses, the control apparatus comprising:
a memory; and
a processor coupled to the memory and the processor configured to:
receive base station information transmitted from a terminal apparatus that communicates with one of the plurality of base station apparatuses, the base station information including measurement results for each of a plurality of signals received with reception quality equal to or higher than a reference value at the terminal apparatus, each of the plurality of signals being transmitted from the plurality of base station apparatuses; and
perform control to improve reception quality of at least one of the plurality of signals transmitted from the plurality of base station apparatuses other than a specified base station apparatus when the base station information does not satisfy a predetermined condition, the specified base station apparatus being a base station apparatus to which the terminal apparatus is being coupled.

2. The control apparatus according to claim 1, wherein
the predetermined condition includes that the base station information includes at least one of the measurement results for the plurality of base station apparatuses other than the specified base station apparatus.

3. The control apparatus according to claim 1, wherein
the predetermined condition includes that received power of a signal transmitted from the specified base station apparatus is higher than reference power.

4. The control apparatus according to claim 3, wherein
the reference power is received power indicating that the terminal apparatus is located at a position other than an end of a communication area of the specified base station apparatus.

5. The control apparatus according to claim 1, wherein:
the reception quality includes received power of each of the plurality of signals received at the terminal apparatus and a degree of interference generated in the plurality of signals received at the terminal apparatus; and wherein
the reception quality is equal to or higher than the reference value when the received power is equal to or higher than a first threshold and when the degree of interference is equal to or lower than a second threshold.

6. The control apparatus according to claim 1, wherein
the measurement result includes received power of a signal received with reception quality equal to or higher than the reference value and includes an identifier of a base station apparatus that has transmitted the signal received with reception quality equal to or higher than the reference value.

7. The control apparatus according to claim 2, wherein the processor is configured to:
after the control to improve the reception quality has been performed, receive base station information from the terminal apparatus again; and
determine whether a measurement result for the plurality of base station apparatuses other than the specified base station apparatus is included in the base station information received again.

8. The control apparatus according to claim 7, wherein the processor is configured to:
when a measurement result for the plurality of base station apparatuses other than the specified base station apparatus is included in the base station information received again, determine that the terminal apparatus is located in an area in which a communication area of the specified base station apparatus and a communication area of a base station apparatus other than the specified base station apparatus overlap.

9. The control apparatus according to claim 7, wherein the processor is configured to:
when a measurement result for a base station apparatus other than the specified base station apparatus is not included in the base station information received again, determine that the terminal apparatus is located in an area which is included in a communication area of the specified base station apparatus and to which a signal transmitted from the base station apparatus other than the specified base station apparatus does not reach.

10. The control apparatus according to claim 7, wherein the processor is configured to:
determine each of a plurality of transmission output of each of the plurality of base station apparatuses according to the measurement result, the measurement result being included in the base station information received again; and
control each of the plurality of transmission output of each of the plurality of base station apparatuses based on a result of a determination of the plurality of transmission output.

11. The control apparatus according to claim 7, wherein the processor is configured to:
when a measurement result for a base station apparatus other than the specified base station apparatus is not included in the base station information received again, estimate a measurement result for the base station apparatus other than the specified base station apparatus.

12. The control apparatus according to claim 1, wherein
each of the plurality of signals is a measurement-use signal; and wherein
the control to improve the reception quality includes processing to stop mapping of a signal other than the measurement-use signal to a frequency band to which the measurement-use signal is to be mapped.

13. The control apparatus according to claim 1, wherein
the control to improve the reception quality includes processing to raise transmission power of a signal transmitted from a base station apparatus other than the specified base station apparatus.

14. The control apparatus according to claim 1, wherein
each of the plurality of signals is a measurement-use signal; and wherein
the control to improve the reception quality includes:
stopping processing to stop mapping of a signal other than the measurement-use signal to a frequency band to which the measurement-use signal is to be mapped; and
power increase processing to raise transmission power of the measurement-use signal transmitted from a base station apparatus other than the specified base station apparatus; and wherein
the processor is configured to:
when the base station information does not satisfy the predetermined condition, execute the stopping processing and receive base station information again from the terminal apparatus; and
when the base station information received again does not satisfy the predetermined condition, execute the power increase processing.

15. A base station apparatus comprising;
a memory; and
a processor coupled to the memory and the processor configured to:
receive base station information transmitted from a terminal apparatus that communicates with one of the plurality of base station apparatuses, the base station information including measurement results for each of a plurality of signals received with reception quality equal to or higher than a reference value at the terminal apparatus, each of the plurality of signals being transmitted from the plurality of base station apparatuses;
transmit the received base station information to a control apparatus; and
receive a specified command, the specified command being transmitted from the control apparatus when the base station information does not satisfy a predetermined condition, the specified command being a command to execute control to improve reception quality of at least one of the plurality of signals transmitted from the plurality of base station apparatuses other than a specified base station apparatus, the specified base station apparatus being a base station apparatus to which the terminal apparatus is being coupled; and
perform processing to improve the reception quality in accordance with the received specified command.

16. A communication system comprising:
a control apparatus including:
a first memory; and
a first processor coupled to the first memory;
a plurality of base station apparatuses, each of the plurality of base station apparatuses including:
a second memory; and
a second processor coupled to the second memory; and
a terminal apparatus, the terminal apparatus communicating with one of the plurality of base station apparatuses, the terminal apparatus including:
a third memory; and
a third processor coupled to the third memory; wherein
the third processor is configured to:
transmit base station information including measurement results for each of a plurality of signals received with reception quality equal to or higher than a reference value at the terminal apparatus, each of the plurality of signals being transmitted from the plurality of base station apparatuses; wherein
the first processor is configured to:
receive base station information transmitted from a terminal apparatus; and
transmit a specified command when the base station information does not satisfy a predetermined condition, the specified command being a command to execute control to improve reception quality of at least one of the plurality of signals transmitted from the plurality of base station apparatuses other than a specified base station apparatus, the specified base station apparatus being a base station apparatus to which the terminal apparatus is being coupled; and wherein
the second processor is configured to:
receive the specified command transmitted from the control apparatus; and
perform processing to improve the reception quality in accordance with the received specified command.
